(19) United States
(12) Patent Application Publication
(10) Pub. No.: US 2016/0217531 A1
(43) Pub. Date: Jul. 28, 2016

(54) COMMUNICATION DEVICE AND SYSTEM INCLUDING THE COMMUNICATION DEVICE

(71) Applicant: Kabushiki Kaisha Toshiba, Minato-ku (JP)

(72) Inventor: Takashi ISHIKAWA, Shinagawa (JP)

(73) Assignee: Kabushiki Kaisha Toshiba, Minato-ku (JP)

(21) Appl. No.: 14/950,085

(22) Filed: Nov. 24, 2015

Related U.S. Application Data
(60) Provisional application No. 62/085,448, filed on Nov. 28, 2014.

(51) Int. Cl. G06Q 40/08

(52) U.S. Cl. CPC G06Q 40/08

(57) ABSTRACT

According to one embodiment, communication device includes a display, the display being capable of showing a first insurance premium of a first insurance and a second insurance premium of a second insurance, and the second insurance premium rises when the first insurance premium rises.

### CROSS REFERENCE TO RELATED APPLICATIONS

This application is based upon and claims the benefit of priority from the prior U.S. Provisional Patent Application No. 62/085,448, filed on Nov. 28, 2014, the entire contents of which are incorporated herein by reference.

### FIELD

Embodiments described herein relate generally to a communication device and a system including the communication device.

### BACKGROUND

In recent years, a wearable device worn on a human body is developed.

### BRIEF DESCRIPTION OF THE DRAWINGS

FIG. 1 is a schematic diagram illustrating the classification of insurances;

FIG. 2 is a schematic diagram illustrating the entire configuration of a system according to a first embodiment;

FIG. 3 illustrates an example of the configuration of a wearable device according to the first embodiment;

FIG. 4 illustrates an example of the configuration of vehicle-mounted sensors and a vehicle according to the first embodiment;

FIG. 5 illustrates an example of the schematic configuration of each of the vehicle-mounted sensors according to the first embodiment;

FIG. 6 illustrates an example of a flowchart showing the operations of sensors 120-1 to 120-3 among the vehicle-mounted sensors according to the first embodiment;

FIG. 7 illustrates an example of the configuration of a communication device according to the first embodiment;

FIG. 8A illustrates an example of a screen displayed on a display unit of a user's communication device when starting to measure basic data for the calculation of an insurance premium in the first embodiment;

FIG. 8B illustrates an example of a screen displayed on the display unit of the user's communication device when requesting the calculation of an insurance premium of a selected insurance in the first embodiment;

FIG. 9 illustrates an example of the configuration of a first server according to the first embodiment;

FIG. 10 illustrates an example of the configuration of a second server according to the first embodiment;

FIG. 11 illustrates an example of the configuration of each of a life insurance terminal and an auto insurance terminal according to the first embodiment;

FIG. 12A illustrates an example of a screen displayed on the life insurance terminal of a life insurance company when an employee of the life insurance company places a request to acquire information regarding a rank or an insurance premium of a user via an application in the first embodiment;

FIG. 12B illustrates an example of a screen displayed on the life insurance terminal of the life insurance company when the life insurance company pays an insurance benefit to the user in the first embodiment;

FIG. 13 is a flowchart illustrating a set-up required to collect biological information according to the first embodiment;

FIG. 14 is a flowchart illustrating steps of calculating a life insurance premium according to the first embodiment;

FIG. 15 is a flowchart illustrating step S7 in FIG. 14;

FIG. 16 is a schematic table used to calculate the amount of rise and drop based on a rank and an age according to the first embodiment;

FIG. 17A is a graph illustrating the distribution of points of all subscribers for a selected insurance during a period ΔT1;

FIG. 17B is a graph illustrating the distribution of points of all subscribers for a selected insurance during a period ΔT2;

FIG. 18A is a flowchart illustrating a set-up required to calculate an auto insurance premium according to the first embodiment;

FIG. 18B is a flowchart illustrating the set-up required to calculate the auto insurance premium according to the first embodiment;

FIG. 19 is a flowchart when the auto insurance premium is calculated according to the first embodiment;

FIG. 20 is a table in which first information and second information are correlated to user's IDs according to the first embodiment;

FIG. 21A illustrates an example of displaying an insurance premium of a second insurance on a display of the communication device according to the first embodiment;

FIG. 21B illustrates an example of displaying an insurance premium of the second insurance on the display of the communication device according to the first embodiment;

FIG. 21C illustrates an example of displaying an insurance premium of the second insurance on the display of the communication device according to the first embodiment;

FIG. 22A illustrates an example of displaying an insurance premium of the second insurance on a display of a communication device of a user H1;

FIG. 22B illustrates an example of displaying an insurance premium of the second insurance on a display of a communication device of a user H2;

FIG. 23A illustrates an example of displaying an insurance premium of the second insurance on a display of a communication device of a user I1;

FIG. 23B illustrates an example of displaying an insurance premium of the second insurance on a display of a communication device of a user I2;

FIG. 23C illustrates an example of displaying an insurance premium of the second insurance on the display of the communication device of the user I2;

FIG. 24 is a schematic diagram illustrating a relationship between display methods of the displays in Examples 1 to 4 and the concept of the embodiment;

FIG. 25 is a flowchart when a first server receives a notification, which is indicative of an insurance benefit being paid to a user, from a third system or a fourth system in a second embodiment;

FIG. 26 is a flowchart illustrating steps of calculating a life insurance premium according to a third embodiment;

FIG. 27 is a flowchart illustrating a method of detecting an event when an insurance benefit is to be paid according to a fourth embodiment;

FIG. 28 is a schematic table in which the conditions of “the first information and the second information” regarding users, who are categorized according to a mortality rate and are in each category, are correlated to the category according to a fifth embodiment;

FIGS. 29A, 29B, 29C and 29D illustrate examples of screens showing steps of extracting and advertising users whom an advertiser wants to advertise on an application according to a sixth embodiment;

FIG. 30 is a flowchart illustrating the operation of the first server according to the sixth embodiment;

FIGS. 31A and 31B illustrate examples of advertisements displayed on a display of a user's communication device according to the sixth embodiment;

FIG. 32 illustrates examples of advertisements displayed on displays of communication devices of users O1 and O2;

FIG. 33 illustrates an example of the configuration of a working memory according to a seventh embodiment;

FIG. 34 illustrates an example of the configuration of a group of memories according to the seventh embodiment;

FIG. 35 illustrates an example of the configuration of a memory port according to the seventh embodiment;

FIG. 36 is a flowchart illustrating the operation of a controller 201-1 according to the seventh embodiment; and

FIG. 37 is a flowchart illustrating an authentication method according to an eighth embodiment.

### DETAILED DESCRIPTION

In general, according to one embodiment, communication device includes a display, the display being capable of showing a first insurance premium of a first insurance and a second insurance premium of a second insurance, the first insurance being different from the second insurance, and the second insurance premium rises when the first insurance premium rises.

According to one embodiment, a system includes a communication device including a display, the display being capable of showing a first insurance premium of a first insurance and a second insurance premium of a second insurance, and the second insurance premium rises when the first insurance premium rises. A system includes a wearable device including a sensor for collecting a first data, the first data being related to biological information, the wearable device being capable of communicating with the communication device. Furthermore the system includes a server capable of communicating with the communication device.

The present embodiment now will be described more fully hereinafter with reference to the accompanying drawings, in which various embodiments are shown. In the drawings, the thickness of layers and regions may be exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “having,” “includes,” “including” and/or variations thereof, when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element (and/or variations thereof), it can be directly on or extend directly onto the other element or intervening elements may also be present. In contrast, when an element is referred to as being “directly on” or extending “directly onto” another element (and/or variations thereof), there are no intervening elements present. It will also be understood that when an element is referred to as being “connected” or “coupled” to another element (and/or variations thereof), it can be directly connected or coupled to the other element or intervening elements may be present. In contrast, when an element is referred to as being “directly connected” or “directly coupled” to another element (and/or variations thereof), there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

Relative terms, such as “lower”, “back”, and “upper” may be used herein to describe one element's relationship to another element as illustrated in the Figures. It will be understood that relative terms are intended to encompass different orientations of the device in addition to the orientation depicted in the Figures. For example, if the structure in the Figure is turned over, elements described as being on the “backside” of substrate would then be oriented on “upper” surface of the substrate. The exemplary term “upper”, can therefore, encompasses both an orientation of “lower” and “upper,” depending on the particular orientation of the figure. Similarly, if the structure in one of the figures is turned over, elements described as “below” or “beneath” other elements would then be oriented “above” the other elements. The exemplary terms “below” or “beneath” can, therefore, encompass both an orientation of above and below.

Embodiments are described herein with reference to cross section and perspective illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Terms used in the embodiments are defined as follows.

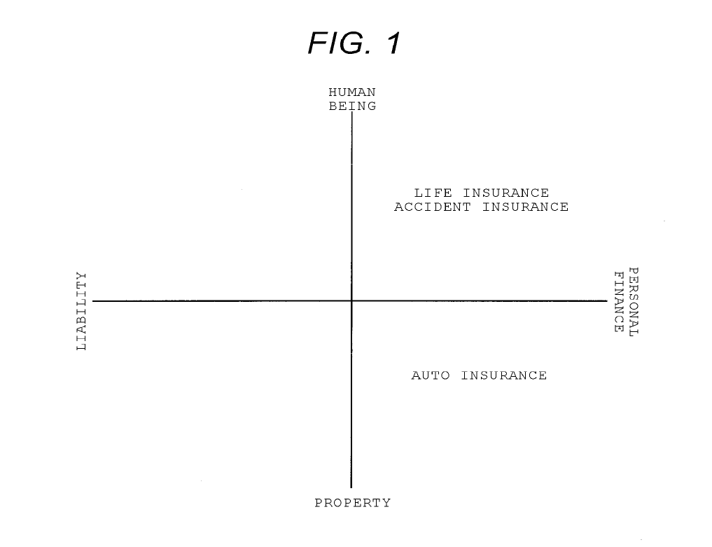

(1) “Insurance”: Insurance is a mutual-aid system that is established in the spirit of mutual aid in which insurance subscribers are fairly charged a given insurance premium appropriately set for the predicted probability of the risk of a contingent accident, and make preparations against a contingency. According to targets of risk, the insurances can be classified into human-being insurances (for example, a death insurances and an illness insurance); property insurances (for example, an insurance against damage to a property); personal finance insurances (for example, an insurance against an income reduction); and liability insurances (for example, an insurance against the burden of indemnity liability). As illustrated in FIG. 1, a life insurance, an accident insurance, and the like are examples of the human-being and personal finance insurances. Examples of the insurance include a fire insurance; an earthquake insurance; an auto insurance; a compulsory auto liability insurance; a traffic personal accident insurance; an ordinary accident insurance; an overseas travel accident insurance; a medical care insurance; a nursing-care insurance; a pension insurance; and the like. The term “same types of insurances” used in the embodiments implies insurances which are included in the same category when insurances are classified according to targets of risk illustrated in FIG. 1. For example, both the “life insurance” and the “accident insurance” are human-being and personal finance insurances, and are included in the same category. In contrast, the auto insurance is a property and personal finance insurance, and is not the same type as the “life insurance” and the “accident insurance”.

The term “the same type of insurance” used in the embodiments may be interpreted as follows. Insurances are classified into the categories as illustrated above, and insurances included in the same category may be deemed to be the same type of insurances. That is, since a life insurance sold by a company A1 and a life insurance sold by a company A2 are different products, but are the same life insurances, both the life insurances are treated as the same type of insurances. In contrast, the life insurance and the accident insurance are not treated as the same type of insurances.

Life insurances may be categorized according to companies which sell the life insurances, and life insurances sold by the same company may be deemed to be the same type of insurances. For example, a life insurance sold by the company A1 and a life insurance sold by the company A2 are not treated as the same type of insurances. When an insurance B1 and an insurance B2 are not the same type of insurances, the insurance B1 and the insurance B2 are referred to as “different types of insurances”.

(2) “Biological Information”: Biological information represents information regarding the body of an animal. The biological information may be in a discrete waveform or a continuous waveform regardless of the form of information. Examples of the biological information include heart rate data; heartbeat waveform data; pulse rate data; pulse waveform data; electrocardiographic waveform data; body temperature waveform data; blood pressure data or blood pressure waveform data; acceleration data; and brain wave data. For example, insofar as biological information is regarding heartbeat, the biological information includes not only the number of heartbeats but also the rate of fluctuation in heartbeat.

The embodiments will be described with reference to the accompanying drawings. In the description hereinbelow, the like reference signs will be assigned to the like portions in all of the drawings.

For the purpose of description, in the embodiments, a life insurance and an auto insurance will be described as examples of two different insurances (different types of insurances). Each of the embodiments can be applied to a plurality of different types of insurances.

### [1] First Embodiment

### [1-1] Example of Entire Configuration of System

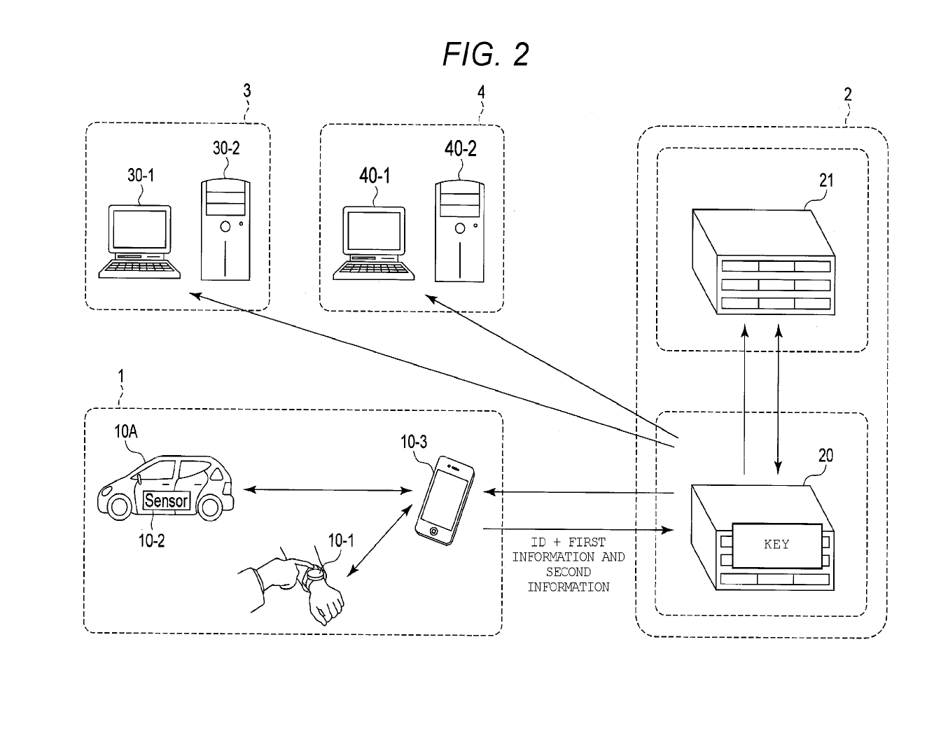

The entire configuration of a system according to an embodiment will be described with reference to FIG. 2.

As illustrated in FIG. 2, generally, the system includes a first system 1; a second system 2; a third system 3; and a fourth system 4.

The first system 1 includes a wearable device 10-1; a sensor 10-2 (hereinafter, which also is referred to as an vehicle-mounted sensor) mounted in a vehicle 10A; and a communication device 10-3. The second system 2 includes a first server 20 and a second server 21. The third system 3 includes a life insurance terminal 30-1 and a third server 30-2, and the fourth system 4 includes an auto insurance terminal 40-1 and a fourth server 40-2.

When the wearable device 10-1 is turned on, and is in contact with a user (who may be an animal, for example, a human being), the wearable device 10-1 acquires biological information (first information) regarding the user. The wearable device 10-1 is a band-like (wrist watch-like) or finger ring-like device that a human being can wrap around the wrist.

The vehicle-mounted sensor 10-2 acquires the following information (second information); information regarding the movement status/driving status of the vehicle 10A; biological information regarding a driver or passengers of the vehicle 10A; or information regarding the vehicle 10A. Examples of these items of information include “weight” of the driver of the vehicle 10A; “the concentration of alcohol” contained in the breath of the driver of the vehicle 10A; and the “angular velocity” of the vehicle 10A.

When the communication device 10-3 can communicate with the wearable device 10-1 and the vehicle-mounted sensor 10-2, the communication device 10-3 receives the first information from the wearable device 10-1, and receives the second information from the vehicle-mounted sensor 10-2. For example, the devices and the sensor are set to be able to communicate with each other by using information (for example, ID) specifying the user or a password. When communication is allowed via this authentication, the wearable device 10-1 and the vehicle-mounted sensor 10-2 transmit the first information and the second information to the communication device 10-3, respectively.

In the embodiment, when the wearable device 10-1 is turned on, the communication of the wearable device 10-1 is allowed, and the wearable device 10-1 measures biological information regarding the user, the wearable device 10-1 always transmits the first information to the communication device 10-3.

Similarly, when the vehicle-mounted sensor 10-2 is turned on, the communication of the vehicle-mounted sensor 10-2 is allowed, and the vehicle-mounted sensor 10-2 measures biological information or the like, the vehicle-mounted sensor 10-2 always transmits the second information to the communication device 10-3.

When the communication device 10-3 receives the first information and the second information, the communication device 10-3 correlates these items of information to a user's ID. The communication device 10-3 transmits the first information and the second information correlated to the user's ID to the second system 2.

The communication device 10-3 is a portable device such as a smart phone or a tablet PC, and insofar as the communication device 10-3 can serves as an access point, the communication device 10-3 may be any type of device.

In the embodiment, the wearable device 10-1 and the communication device 10-3 may not be separate devices, and may be a single device.

The first server 20 receives the first information and the second information correlated to the user's ID from the communication device 10-3 of the first system 1. The first server 20 temporarily stores the first information and the second information correlated to the user's ID.

When the first system 1, the third system 3, or the fourth system 4 requests the first server 20 to calculate an insurance premium of a user, that is, the first server 20 receives an ID of a user who is a target for the calculation of an insurance premium, a command to request the calculation of an insurance premium, and the like, the first server 20 calculates the insurance premium of the user.

The configuration of the first server 20 is not limited to a single server, and the first server 20 may be made up of a plurality of servers 20-1 to 20-n (n: natural number).

The first server 20 stores key information. This key information is codes and rules used to encrypt the first information and the second information which are temporarily stored in the first server 20. The first server 20 restores the encrypted first information and the encrypted second information using the key information. The first information and the second information may be encrypted using a single item of key information or a plurality of items of key information, and the encrypted first information and the encrypted second information may be restored using a plurality of items of key information.

The first server 20 encrypts the first information and the second information correlated to the user's ID according to the key information, and transmits the items of encrypted information to the second server 21.

After the first server 20 transmits the items of encrypted information to the second server 21, the first server 20 may continue to store only the key information, and delete the first information and the second information correlated to the user's ID from a memory 22-3 of the first server 20.

When the first server 20 receives a command to request the calculation of an insurance premium, and does not store the first information and the second information correlated to the user's ID, a command to request the transmission of the items of encrypted information is transmitted from the first server 20 to the second server 21.

The first server 20 receives the items of encrypted information, restores the first information and the second information correlated to the user's ID using the key information, and calculates an insurance premium.

The second server 21 stores the items of encrypted information. The configuration of the second server 21 is not limited to a single server, and the second server 21 may include a plurality of servers 21-1 to 21-n (n: natural number).

When the second server 21 receives a command, which requests the transmission of the items of encrypted information, from the first server 20, the second server 21 transmits the items of encrypted information to the first server 20.

Both items of data stored in the first server 20 and the second server 21 are not limited to items of data owned by the same company, and for example, the data stored in the first server 20 may belong to a company C1, and the data stored in the second server 21 may belong to a company C2. When the same company owns both items of data, the first server 20 and the second server 21 may be physically the same server.

The life insurance terminal 30-1 is connected to the third server 30-2 via a network. For example, an employee of a life insurance company can input a command to the life insurance terminal 30-1, and request the first server 20 to calculate an insurance premium of a user. Specifically, the third system 3 transmits a user's ID, a command to request the calculation of the insurance premium, and the like, to the first server 20.

Instead of a user's ID, a command to request the calculation of the insurance premium, and the like being transmitted from the third system 3 to the first server 20, a user's ID, a command to request the calculation of information regarding a user's rank, and the like may be transmitted from the third system 3 to the first server 20. The third server 30-2 of the third system 3 stores a program regarding a method of calculating an insurance premium according to rank. The third server 30-2 receives the information regarding the user's rank from the second system 2, calculates an insurance premium of the user using this program, and outputs the calculated insurance premium to the life insurance terminal 30-1. The life insurance terminal 30-1 displays the insurance premium received from the third server 30-2 on a display unit (display) 31-5.

The auto insurance terminal 40-1 is connected to the fourth server 40-2 via a network. For example, an employee of an auto insurance company can input a command to the auto insurance terminal 40-1, and request the first server 20 to calculate an insurance premium of a user. Specifically, a user's ID, a command to request the calculation of an insurance premium, and the like are transmitted from the fourth system 4 to the first server 20.

Instead of a user's ID, a command to request the calculation of the insurance premium, and the like being transmitted from the fourth system 4 to the first server 20, a user's ID, a command to request the calculation of information regarding a user's rank, and the like may be transmitted from the fourth system 4 to the first server 20. The fourth server 40-2 of the fourth system 4 stores a program regarding a method of calculating an insurance premium according to rank. The fourth server 40-2 receives the information regarding the user's rank from the second system 2, calculates an insurance premium of the user using this program, and outputs the calculated insurance premium to the auto insurance terminal 40-1. The auto insurance terminal 40-1 displays the insurance premium received from the fourth server 40-2 on the display unit (display) 31-5.

For example, the life insurance company owns the third system 3, and the auto insurance company owns the fourth system 4. The life insurance company or the auto insurance company charges the user the insurance premium that is displayed on the life insurance terminal 30-1 or the auto insurance terminal 40-1. The user pays the insurance premium to the life insurance company or the auto insurance company based on this charge.

When the life insurance company or the auto insurance company pays an insurance benefit to a user, the third system 3 or the fourth system 4 may notify the first server 20 via a network that the insurance benefit is paid to the user. When the first server 20 receives this notification, the first server 20 acquires items of biological information over a predetermined time period before and after the receipt of the notification. Specifically, when the first server 20 stores the first information and the second information, the first server 20 extracts the items of biological information therefrom over the predetermined time range before and after the receipt of the notification. When the first server 20 does not store the first information and the second information, the first server 20 reads the items of encrypted information from the second server 21, restores the first information and the second information, and extracts the items of biological information therefrom over the predetermined time range before and after the receipt of the notification.

The first server 20 detects the differences between the items of biological information over the predetermined time period before and after the receipt of the notification, and calculates conditions based on the differences. Specifically, when an average pulse rate is a beats per second during a given period before the notification, and an average pulse rate is β beats per second during a given period after the notification, the first server 20 sets the conditions to a “change from a beats per second to β beats per second”. A method of evaluating the biological information is not limited to an evaluation method that is based on the averaging of parameter values, and for example, the biological information may be evaluated based on the averaging and distribution of parameter values.

Whenever the set conditions are changed, the first server 20 transmits conditions data to the communication device 10-3 of the first system 1 along with a command and the like. The communication device 10-3 sets conditions based on the received conditions data.

When the first server 20 receives the notification correlated to the rank of the type of an illness and the like, the first server 20 stores the set conditions and the flag correlated to each other. In this case, whenever the set conditions are changed, the first server 20 transmits the conditions and the flag correlated to each other to the communication device 10-3 of the first system 1 along with a command and the like. The communication device 10-3 sets conditions along with the flag based on the received conditions.

[1-1-1] Wearable Device 10-1

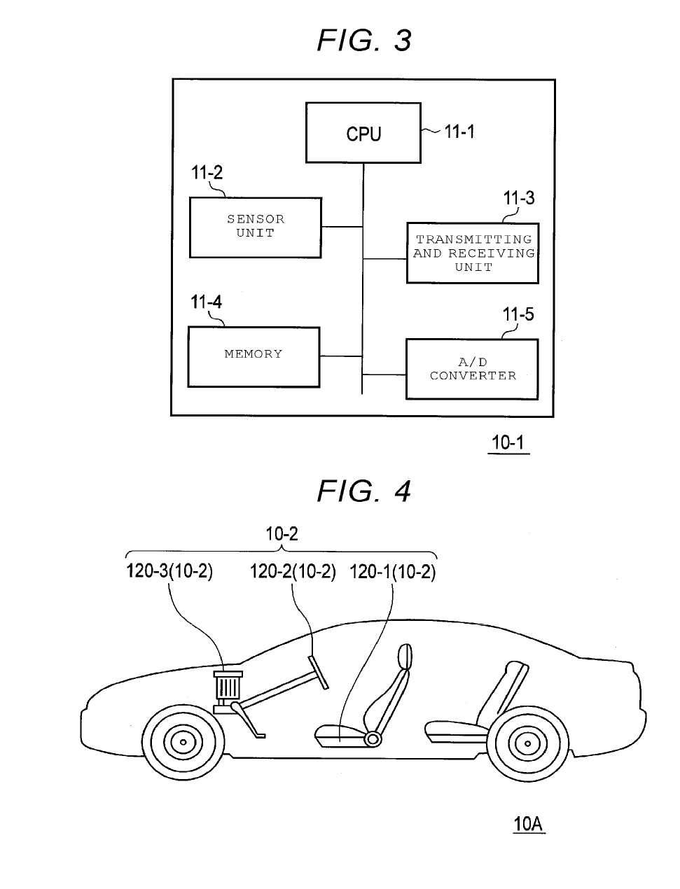

The configuration of the wearable device 10-1 will be described with reference to FIG. 3.

As illustrated in FIG. 3, the wearable device 10-1 includes a CPU (computational unit) 11-1; a sensor unit 11-2; a transmitting and receiving unit 11-3; a memory (storage unit) 11-4; and an A/D converter 11-5.

The CPU 11-1 performs a desired process on biological information acquired from the sensor unit 11-2.

The sensor unit 11-2 acquires biological information from a user. Insofar as the sensor unit 11-2 can acquire biological information from a user, the sensor unit 11-2 may be in contact with any part of the user, for example, the chest, the head, or the like of the user other than the wrist.

For example, the transmitting and receiving unit 11-3 transmits data processed by the CPU 11-1 to the communication device 10-3 in a wireless manner. A user's ID may also be transmitted to the communication device 10-3 along with the processed data.

The memory 11-4 temporarily stores the data processed by the CPU 11-1 and the biological information acquired from the sensor 11-2.

The A/D converter 11-5 converts analog data acquired by the sensor unit 11-2 into digital data.

The wearable device 10-1 may directly transmit the data processed by the CPU 11-1 to the second system 2 not via the communication device 10-3.

The wearable device 10-1 can communicate with another wearable device 10-1 in a wireless manner. That is, the respective transmitting and receiving units 11-3 of a plurality of the wearable devices 10-1 can communicate with each other in a wireless manner.

A plurality of the wearable devices 10-1 worn on the body of a single user can communicate with each other via human body communication. For example, when the wearable devices 10-1 are worn on the body of a single user at two locations or more, the wearable devices 10-1 may communicate with each other via human body communication, and each of the wearable devices 10-1 may communicate with the communication device 10-3 in a wireless manner. The human body communication referred to here is a form of communication in which a human body that is a dielectric substance is used as a communication medium, and is a communication method that is not wire communication and wireless communication. For example, the human body communication is disclosed in U.S. patent application Ser. No. 13/051,190 entitled “HUMAN BODY COMMUNICATION APPARATUS AND AUTHENTICATION METHOD OF THE SAME”, filed on Mar. 18, 2011. In addition, the human body communication is disclosed in U.S. patent application Ser. No. 12/051,194 entitled “COMMUNICATION APPARATUS AND COMMUNICATION SYSTEM”, filed on Mar. 18, 2011. The entire contents of these patent applications are incorporated herein by reference.

[1-1-2] Vehicle-Mounted Sensor 10-2

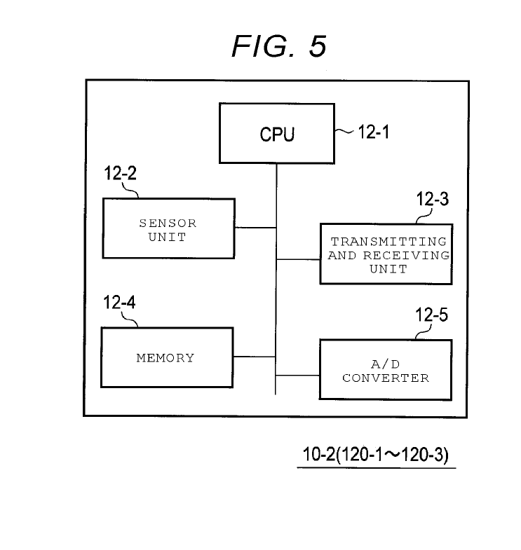

The configuration of the vehicle-mounted sensor 10-2 will be described with reference to FIGS. 4 and 5. As illustrated in FIG. 4, the vehicle-mounted sensor 10-2 includes a plurality of sensors 120-1 to 120-3. The vehicle-mounted sensor 10-2 includes a weight sensor 120-1, a breath sensor 120-2; a gyro sensor 120-3; and the like. The sensors 120-1 to 120-3 have substantially the same configuration, and the configuration of each sensor is illustrated in FIG. 5.

As illustrated in FIG. 5, the vehicle-mounted sensor 10-2 includes a CPU (computational unit) 12-1; a sensor unit 12-2; a transmitting and receiving unit 12-3; a memory (storage unit) 12-4; and an A/D converter 12-5.

The CPU 12-1 performs a desired process on data acquired by the sensor unit 12-2.

The sensor unit 12-2 acquires the second information.

The transmitting and receiving unit 12-3 transmits the second information acquired by the sensor unit 12-2 to the transmitting and receiving unit 13-3 of the communication device 10-3. The second information may be transmitted to the communication device 10-3 along with a user's ID.

The memory 12-4 stores the data processed by the CPU 12-1, and the second information acquired by the sensor unit 12-2.

The A/D converter 12-5 converts analog data acquired by the sensor unit 12-2 into digital data.

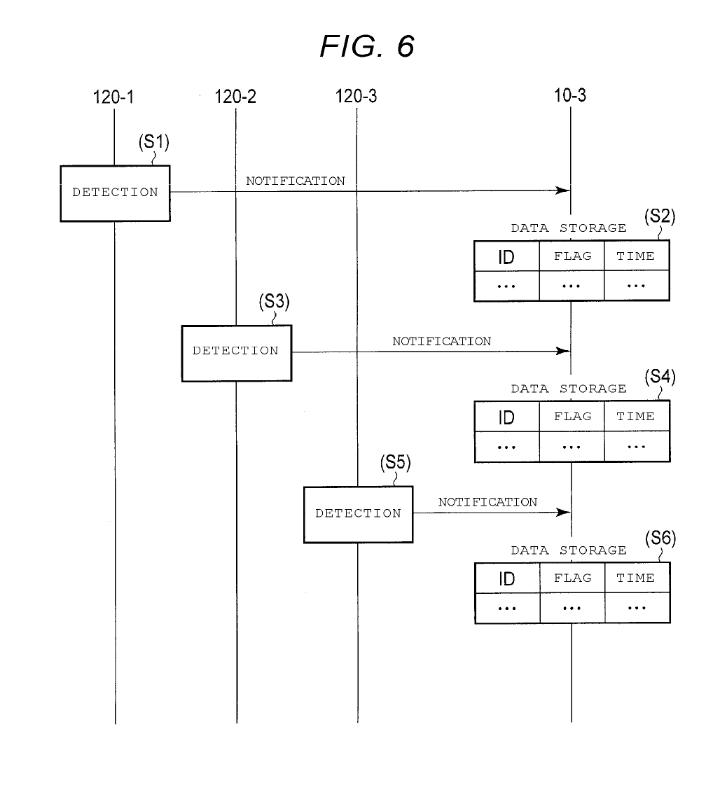

Hereinafter, each of the sensors 120-1 to 120-3 will be described with reference to FIG. 6.

The weight sensor 120-1 determines whether a driver (user) of the vehicle 10A boards the vehicle 10A. For example, the weight sensor 120-1 is provided on a driver's seat. When the weight sensor 120-1 is turned on, and the sensor unit 12-2 detects weight of the driver, the CPU 12-1 controls the transmitting and receiving unit 12-3 such that the communication device 10-3 is notified that the user boards the vehicle 10A (S1). The communication device 10-3 receives this notification, and stores a flag indicating that the user boards the vehicle 10A, a user's ID and the time correlated to each other (S2).

The breath sensor 120-2 determines whether a user drinks alcohol. For example, the breath sensor 120-2 is provided on a steering wheel. When the concentration of alcohol contained in the breath of the user, which is acquired by the sensor unit 12-2 of the breath sensor 120-2, exceeds a threshold value stored in the memory 12-4 of the breath sensor 120-2, the CPU 12-1 controls the transmitting and receiving unit 12-3 such that the communication device 10-3 is notified of drunken driving (S3). The communication device 10-3 receives this notification, and stores a flag indicative of drunken driving, a user's ID, and the time correlated to each other (S4).

The gyro sensor 120-3 determines whether the vehicle 10A is in a meandering driving mode. For example, the gyro sensor 120-3 is provided in a rearview mirror; however, insofar as the gyro sensor 120-3 can detect meandering driving, the gyro sensor 120-3 may be provided on any part of the vehicle 10A. When the angular velocity detected by the sensor unit 12-2 of the gyro sensor 120-3 exceeds a threshold value stored in the memory 12-4 of the gyro sensor 120-3, the CPU 12-1 controls the transmitting and receiving unit 12-3 such that the communication device 10-3 is notified of drunken driving (S5). The communication device 10-3 receives this notification, and stores a flag indicative of meandering driving, a user's ID, and the time correlated to each other (S6).

A sensor capable of acquiring biological information may be mounted on the steering wheel of the vehicle 10A.

In the embodiment, each of the sensors 120-1 to 120-3 in FIGS. 4 and 5 includes the CPU 12-1; the sensor unit 12-2; the transmitting and receiving unit 12-3; the memory 12-4; and the A/D converter 12-5 which are illustrated in FIG. 5; however, the configuration of each of the sensors 120-1 to 120-3 is not limited to the configuration in the embodiment, and for example, the sensors 120-1 to 120-3 may share the CPU 12-1, the transmitting and receiving unit 12-3, the memory 12-4, and the A/D converter 12-5.

[1-1-3] Communication Device 10-3

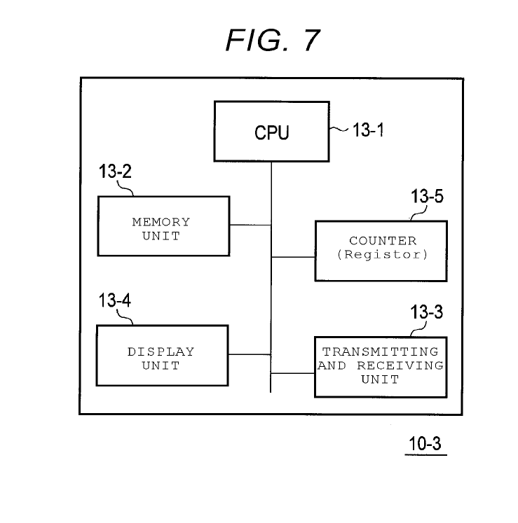

The configuration of the communication device 10-3 will be described with reference to FIG. 7.

As illustrated in FIG. 7, the communication device 10-3 includes a CPU (computational unit) 13-1; a memory (storage unit) 13-2; a transmitting and receiving unit 13-3; a display unit 13-4; and a counter (register) 13-5.

The memory 13-2 stores an application for displaying an insurance premium on the communication device 10-3. This application is down-loaded to the communication device 10-3 via Internet or the like. The application is installed on the communication device 10-3.

The memory 13-2 stores a table in which the product information and the type of the wearable device 10-1 or the vehicle-mounted sensor 10-2 are correlated to the detectable first and second information. In addition, the memory 13-2 stores a table in which the first information and the second information are correlated to the types of insurances, the insurance premiums of which can be calculated.

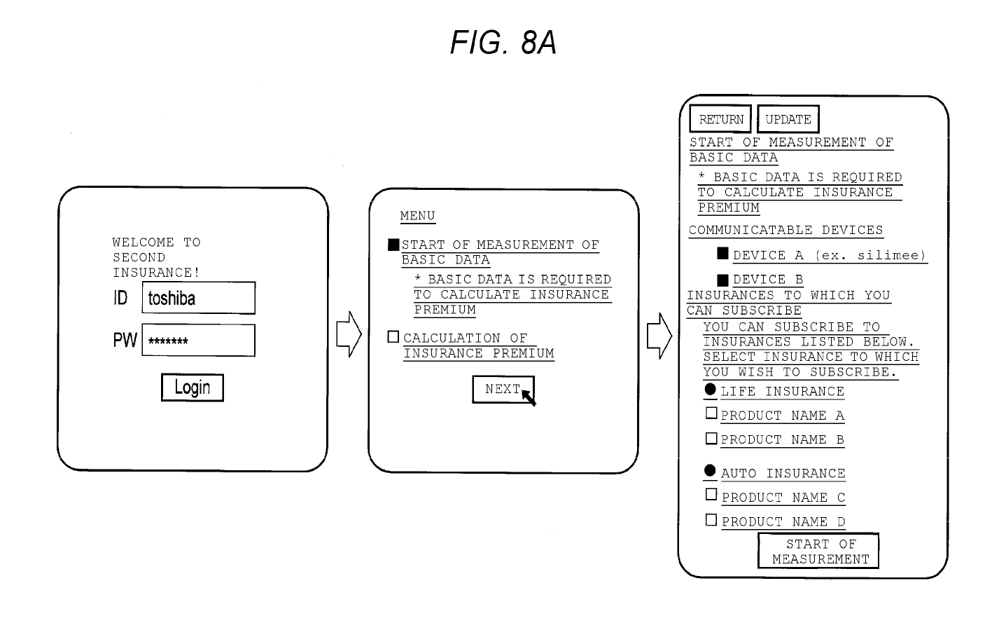

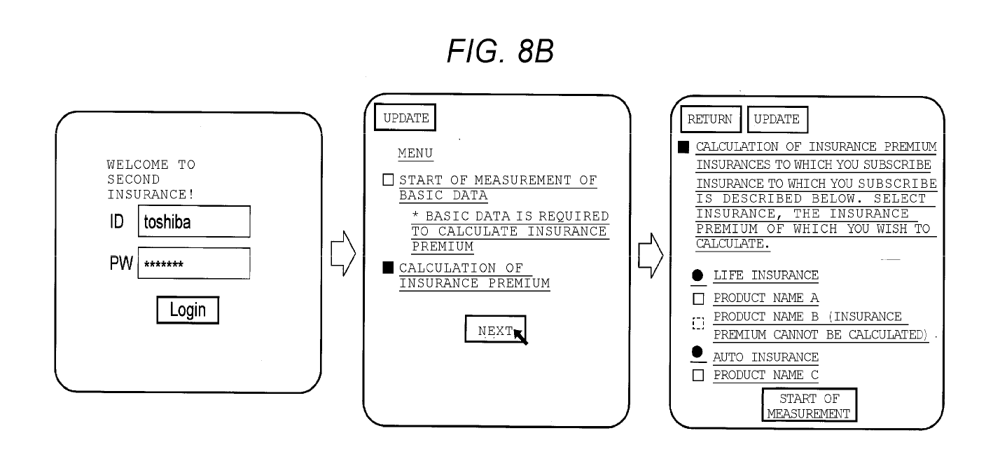

The CPU 13-1 controls the entirety of the communication device 10-3. When a user starts the application that has been already downloaded on the communication device 10-3, and inputs a command to start the measurement of basic data (which is required to calculate an insurance premium) to the communication device 10-3 (refer to FIG. 8A), the CPU 13-1 communicates with the wearable device 10-1 or the vehicle-mounted sensor 10-2. For example, while the wearable device 10-1 or the vehicle-mounted sensor 10-2 is charged with a power source, the communication device 10-3 communicates with the wearable device 10-1 or the vehicle-mounted sensor 10-2 via Bluetooth (a trademark), and detects the wearable device 10-1 or the vehicle-mounted sensor 10-2.

Even if a user is not a subscriber for a second insurance (to be described later), the user can down-load, and start the application. For example, even if a person is examining the subscription to the second insurance, when the person can down-load the application, and acquire an ID, the person can use the application. When a person who is examining the subscription to the second insurance transmits the first information and the second information over a desired period to the first server 20 via the communication device 10-3, the person can acquire a provisional insurance premium of the second insurance. The person who is examining the subscription to the second insurance can determine whether to subscribe to the second insurance, based on this provisional insurance premium.

The CPU 13-1 displays the following information on the display unit 13-4: the product information or the types of the detected wearable device 10-1 or the detected vehicle-mounted sensor 10-2, and the types of insurances, the insurance premiums of which can be calculated. As illustrated in FIG. 8A, the display unit 13-4 of the communication device 10-3 displays the detected wearable device 10-1 or the detected vehicle-mounted sensor 10-2.

When a user selects the type of an insurance, the insurance premium of which the user desires to calculate, and issues an instruction to start to collect biological information which is a basis in calculating an insurance premium, the CPU 13-1 of the communication device 10-3 notifies the first server 20, via the transmitting and receiving unit 13-3, that the collection of the biological information is started. That is, as illustrated in FIG. 8A, when a user selects an insurance to which the user wish to subscribe, and pushes a measurement start button, the CPU 13-1 of the communication device 10-3 notifies the first server 20, via the transmitting and receiving unit 13-3, that the collection of the biological information is started.

The CPU 13-1 of the communication device 10-3 starts to receive the first information and the second information from the wearable device 10-1 and the vehicle-mounted sensor 10-2 via the transmitting and receiving unit 13-3.

When a user starts the application, selects the type of an insurance on a screen, the insurance premium of which the user wishes to calculate, and places a request for the calculation of the insurance premium of the selected insurance (refer to FIG. 8B), via the transmitting and receiving unit 13-3, the CPU 13-1 of the communication device 10-3 notifies the first server 20 of an instruction to calculate the insurance premium. That is, as illustrated in FIG. 8B, when a user selects an insurance, the insurance premium of which the user wishes to calculate, and pushes a calculation start button, via the transmitting and receiving unit 13-3, the CPU 13-1 of the communication device 10-3 notifies the first server 20 of an instruction to calculate the insurance premium.

When the communication device 10-3 transmits a notification message, information stored in the counter 13-5 is also transmitted to the first server 20. The information stored in the counter 13-5 will be described in detail later.

The communication device 10-3 sets the conditions received from the first server 20. The CPU 13-1 determines whether the first information and the second information received from the wearable device 10-1 and the vehicle-mounted sensor 10-2 satisfy the conditions. For example, the conditions are set for each illness. For example, when the received first information and the received second information satisfy the conditions of an illness, the CPU 13-1 counts up the number of times of getting sick in the illness. The number of times is stored in the counter 13-5 of the communication device 10-3. In the embodiment, the counter 13-5 stores the number of times; however, without being limited to the number of times, insofar as the symptoms and the severity of an illness can be discriminated based on information stored in the counter 13-5, the information may have any form.

The transmitting and receiving unit 13-3 transmits to and receives data from the wearable device 10-1, the vehicle-mounted sensor 10-2, and the first server 20. The transmitting and receiving unit 13-3 is controlled by the CPU 13-1. The transmitting and receiving unit 13-3 transmits to and receives the data of the first information and the data of the second information from the wearable device 10-1, the vehicle-mounted sensor 10-2, and the first server 20.

The communication device 10-3 has a GPS function, and examines a case in which an electronic payment can be made. In this case, when an electronic payment is made at a hospital or a pharmacy via the communication device 10-3, the symptoms of an illness are stored in the memory 13-2 of the communication device 10-3. For example, when a drug D1 and a drug D2 are prescribed at a pharmacy, and an electronic payment is made via the communication device 10-3, the CPU 13-1 of the communication device 10-3 estimates an illness for which the drug D1 and the drug D2 are prescribed at the same time. When the memory 13-2 of the communication device 10-3 stores a table in which drugs are correlated to illnesses, the CPU 13-1 estimates an illness with reference to this table. When the first sever 20 stores such a table, via the transmitting and receiving unit 13-3, the CPU 13-1 notifies the first server 20 of an instruction to estimate an illness for which the drug D1 and the drug D2 are used at the same time. The transmitting and receiving unit 13-3 receives information regarding the corresponding illness from the first server 20, and the CPU 13-1 estimates the illness. Thereafter, the CPU 13-1 counts the event as user's getting sick in the estimated illness once, and the memory 13-2 stores the illness and the count correlated to each other. The CPU 13-1 controls the transmitting and receiving unit 13-3 such that the transmitting and receiving unit transmits the symptoms of the illness to the first server 20.

In the embodiment, the transmitting and receiving unit 13-3 transmits the first information and the like to the first server 20; however, a method of transmitting the first information and the like is not limited to the method in the embodiment, and for example, the transmitting and receiving unit 13-3 may directly transmit the first information and the like to the second server 21 not via the first server 20.

In the case given in the embodiment, an electronic payment is made at a hospital or a pharmacy via the communication device 10-3, and such an electronic payment may cause a rise in the insurance premium of the second insurance of a user. For this reason, the user is deemed to avoid an electronic payment at a hospital or a pharmacy. An incentive may be given to the user so that the user can actively make an electronic payment. For example, when the user makes an electronic payment at a hospital or a pharmacy, a predetermined amount of money is deducted from the insurance premium of the second insurance. The communication device 10-3 receives the content of an electronic payment from a host (for example, a POS terminal) that performs an electronic payment process, and the memory 13-2 of the communication device 10-3 stores a flag indicating that the electronic payment is made. When the communication device 10-3 displays the insurance premium of the second insurance, the CPU 13-1 computes an amount of money that is obtained by deducting the predetermined amount of money from the insurance premium of the second insurance, and notifies the display unit 13-4 of the computed amount of money. The display unit 13-4 displays the computed amount of money (which is obtained by deducting the predetermined amount of money from the insurance premium of the second insurance) as a new insurance premium of the second insurance.

For example, when a user requests the calculation of an insurance premium of a selected insurance, the display unit 13-4, which is a display of the communication device 10-3, displays the insurance premium (a life insurance premium, or an auto insurance premium) of the selected insurance. Depending on the product content or the type of a selected insurance, different biological information is used as a basis in calculating an insurance premium. An insurance premium of an insurance may be calculated based on biological information regarding a user which is collected for one month; however, an insurance premium of another insurance may be calculated based on biological information regarding a user which is collected for one year. The selection of biological information used as a basis in calculating the insurance premium is made depending on the product content or the type of a selected insurance. The display unit 13-4 may display an insurance premium that is calculated based on biological information regarding a user collected for a desired period (for example, one month) before a request is placed, and may display an insurance premium (for example, an insurance premium for the last month) that is calculated based on biological information regarding the user collected prior to the desired period. Items of information displayed on the display unit 13-4 are not limited to those described above, and for example, the display unit 13-4 may display a change rate or the difference between the insurance premium for the given month and the insurance premium for the last month. In addition, the display unit 13-4 may display advertisements other than an insurance premium. Details will be described later.

[1-1-4] First Server 20

The first server 20 has (1) a function of receiving the first information and the second information from the wearable device 10-1 and the vehicle-mounted sensor 10-2 of the first system 1, and temporarily storing the first information and the second information. The first server 20 has (2) a function of calculating a user's rank or an insurance premium of a user based on the received data.

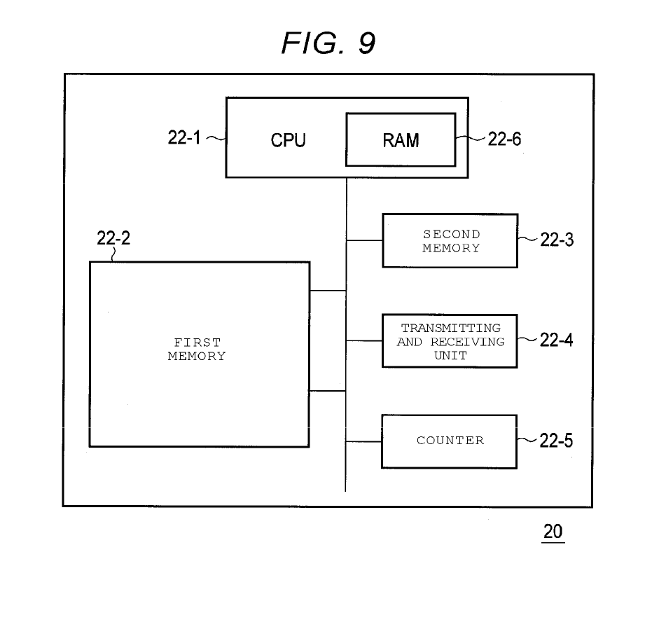

The configuration of the first server 20 will be described with reference to FIG. 9.

As illustrated in FIG. 9, the first server 20 includes a CPU (computational unit) 22-1; a first memory 22-2; a second memory 22-3; a transmitting and receiving unit 22-4; and a counter 22-5.

The CPU 22-1 includes a working memory (denoted as a RAM) 22-6. When the first server 20 receives a notification, which is indicative of the start of collecting biological information, from the communication device 10-3, the first server 20 stores a user's ID and the time for the start of collection correlated to each other in the second memory 22-3. When the first server 20 receives the first information and the second information from the communication device 10-3 after receiving the notification indicative of the start of collection, the first server 20 temporarily stores the first information, the second information, and the like correlated to the ID in the second memory 22-3.

When the CPU 22-1 receives items of the first information and items of the second information regarding a plurality of users from a plurality of the communication device 10-3, and transmits the items of the first information and the items of the second information to the second server 21, the CPU 22-1 encrypts the items of the first information and the items of the second information regarding the plurality of users, and the like using the key information. For example, the four encryption methods to be described below can be examined. The first information and the second information regarding a user are assumed to be correlated to a user's ID before the first information and the second information are encrypted.

(1) Each of the first information and the second information regarding each user is divided according to a predetermined period. The divided items of the first information and the divided items of the second information in the same period are shuffled across the users and encrypted.

For example, each of the first information and the second information regarding a user E1 is divided into a first period information and a second period information. Similarly, each of the first information and the second information regarding each of users E2 and E3 is divided into the first period information and the second period information. Thereafter, encryption is performed by shuffling items of the first period information, and shuffling items of the second period information in such a way that the items of the information are not correlated to the users' IDs.

(2) After the shuffling in (1) is performed, the items of the information are shuffled across time series, and are encrypted. In the aforementioned example, after the shuffling described in (1) is performed, the items of the first period information and the items of the second period information in the same column are exchanged and encrypted.

(3) Each of the first information and the second information for each user is divided according to the type of information (for example, according to a pulse rate or body temperature). Items of data in an information type column are shuffled and encrypted.

When the first server 20 receives an instruction to calculate an insurance premium from the communication device 10-3, a command to request the transmission of encrypted information is transmitted from the CPU 22-1 of the first server 20 to the second server 21 via the transmitting and receiving unit 22-4. The CPU 22-1 receives the encrypted information, causes the working memory 22-6 to read the key information stored in the first memory 22-2, and restores the first information and the second information correlated to a user's ID using the key information. The CPU 22-1 calculates an insurance premium based on information regarding the product content or the type of an insurance which is selected by a user and received from the communication device 10-3, the restored first information and the restored second information, information regarding the symptoms of an illness which is received from the communication device 10-3, and the like.

A insurance premium calculation method will be described in detail later, and the CPU 22-1 reads necessary information from the restored first information and the restored second information, based on the information regarding the product content or the type of the insurance selected by the user, and determines whether the conditions of illnesses which are considerable according to the product content or the type of the selected insurance are satisfied. The first memory 22-2 stores a table in which illnesses are correlated to the product content or the types of insurances. Among the illnesses which are considerable according to the product content or the type of the selected insurance, the illness (information regarding the symptoms of the illness received from the communication device 10-3) which has been already determined by the communication device 10-3 is not determined again by the first server 20.

The CPU 22-1 evaluates user's characteristics from the information regarding the symptoms of the illness, and a result of whether the conditions of the illness are satisfied. The CPU 22-1 evaluates a user's rank by causing the working memory 22-6 to read data (the first information, the second information, or the like) of other subscribers for the selected insurance, and evaluating a relative relationship between the user and other subscribers for the insurance selected by the user. The CPU 22-1 calculates an insurance premium of the user based on this rank as one variable.

The first memory 22-2 stores computational programs, “the key information”, a first table, a second table, a third table, a life insurance standard life table, and the like.

The computational programs include a program that determines whether the first information and the second information satisfy the conditions of illnesses which are considerable according to the product content or the type of a selected insurance; a program that evaluates a user's rank from information regarding the symptoms of illnesses, and a result of whether the conditions of an illness are satisfied; a program that calculates an insurance premium of the second insurance of a user based on a user's rank as one variable; and a program that compares a calculated insurance premium of a first insurance and a calculated insurance premium of the second insurance.

The first insurance referred to here is an insurance, the insurance premium of which is set in advance according to insurance product, age, and gender in such a way that the expenditures and revenues of all companies in the insurance industry are balanced with each other. That is, a change in the insurance premium of the first insurance is not dependent on the first information or the second information regarding a user, a user's rank, and the like. The second insurance is an insurance, the insurance premium of which is set based on the first information or the second information regarding a user, and a user's rank. That is, the insurance premium of the second insurance is dependent on the first information or the second information regarding a user, a user's rank, and the like.

The first table includes information regarding the insurance premium of the first insurance. The first table is a table in which insurance premiums set according to the product content or the types of the first insurance, age, and gender are correlated thereto.

The second table is a table in which the determination conditions of an illness are correlated to the illness. The second table stores a plurality of illnesses, and the conditions corresponding to the illnesses. The embodiment described herein is not limitedly applied to a case in which the conditions related to the entireties of the first information and the second information are set; however, the conditions may be set for only illness information among the first information and the second information.

As an example, the conditions are set to determine whether an illness is acute cardiac syndromes (ACS) using an electrocardiogram. For example, a specific method is disclosed in U.S. patent application Ser. No. 09/634,355 entitled “Method and apparatus to detect acute cardiac syndromes in specified groups of patients using EGG”, filed on Aug. 9, 2000. The entire content of this patent application is incorporated herein by reference.

In the embodiment, it is assumed that the first server 20 has already stored the conditions.

The third table is a table in which user's ranks are correlated to the amounts of rise and drop relative to net premium valuations. When the CPU 22-1 evaluates a user's rank from the relative relationship between a user and other subscribers for the insurance to which the user subscribes, the CPU 22-1 uses the third table.

The life insurance standard life table illustrates basic numerical values required to calculate a life insurance premium. A net premium valuation is calculated using the life insurance standard life table.

The net premium valuation represents an insurance premium which is set using the life insurance standard life table in such a way that the total of insurance benefits is balanced with the total of insurance premiums. Specifically, when it is assumed that the period of insurance is i years, the net premium valuation of a life insurance is P, and an insurance benefit IP is paid when an insurance subscriber passes away, the net premium valuation P of the life insurance satisfies Expression (1) below.

$${\sum }_{i} P * {a}_{i} * {b}_{i} = {\sum }_{i} IP * {c}_{i} * {d}_{i} \qquad ( 1 )$$

Here, aᵢ represents the number of survivors during i years, bᵢ represents a present value rate in the beginning of each year during i years, cᵢ represents the number of deaths during i years, dᵢ represents a present value rate in the middle of each year during i years, the net premium valuation P changes according to the product content or the type of an insurance. The number of survivors and the number of deaths are calculated based on the life insurance standard life table. The net premium valuation P is assumed to be constant in Expression (1); however, the value of the net premium valuation P is not limited to a constant value, and for example, the net premium valuation P may change according to a change in each of variables (for example, the number of deaths) in the aforementioned expression. The net premium valuation may change at any time; however, the pattern of a change in the net premium valuation is not limited to a pattern in which the net premium valuation changes at any time, and for example, the net premium valuation may change on a yearly or monthly basis. The net premium valuation may change when an event (an earthquake, secondary damage associated with an earthquake, or the like) occurs to cause a change in each of the variables (for example a mortality rate).

The second memory 22-3 temporarily stores the first information, the second information, and the like which are received from the wearable device 10-1 and the vehicle-mounted sensor 10-2.

The transmitting and receiving unit 22-4 receives the first information and the second information from the transmitting and receiving unit 13-3 of the communication device 10-3 along a user's ID. The CPU 22-1 controls the transmitting and receiving unit 22-4 such that the second memory 22-3 stores these items of information.

The transmitting and receiving unit 22-4 transmits the user's rank and the insurance premium of the first insurance (which are calculated by the CPU 22-1) to the communication device 10-3, and the third system 3 and the fourth system 4 (to be described).

The counter 22-5 measures a current time.

[1-1-5] Second Server 21

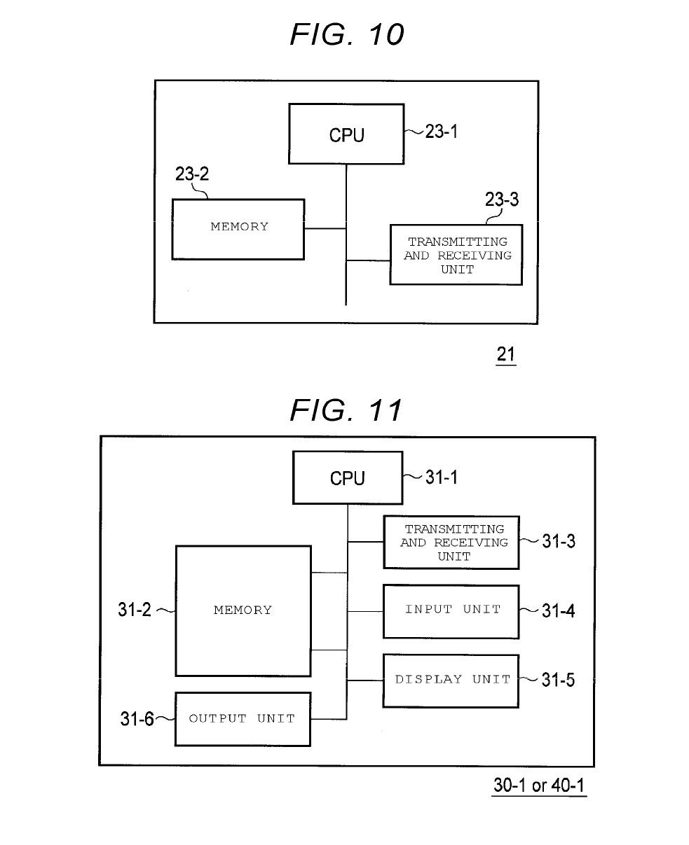

The configuration of the second server 21 will be described with reference to FIG. 10.

As illustrated in FIG. 10, the second server 21 includes a CPU (computational unit) 23-1; a memory (storage unit) 23-2; and a transmitting and receiving unit 23-3.

When the CPU 23-1 receives a command, which requests the transmission of encrypted information, from the first server 20, the CPU 23-1 transmits the encrypted information to the first server 20 via the transmitting and receiving unit 23-3.

The memory 23-2 can store the encrypted information.

The transmitting and receiving unit 23-3 receives the encrypted information from the transmitting and receiving unit 22-4 of the first server 20. The CPU 23-1 controls the transmitting and receiving unit 23-3 such that the transmitting and receiving unit 23-3 transmits the encrypted information to the memory 23-2.

The configuration of the second server 21 is not limited to a single server, and the second server 21 may be made up of the plurality of second servers 21-1 to 21-n. The plurality of second servers 21-1 to 21-n may collectively have the aforementioned function.

[1-1-6] Life Insurance Terminal 30-1 and Auto Insurance Terminal 40-1

The configuration of each of the life insurance terminal 30-1 and the auto insurance terminal 40-1 will be described with reference to FIG. 11. Since both the life insurance terminal 30-1 and the auto insurance terminal 40-1 have the same configuration, only the life insurance terminal 30-1 will be described for the purpose of description.

As illustrated in FIG. 11, the life insurance terminal 30-1 includes a CPU (computational unit) 31-1; a memory (storage unit) 31-2; a transmitting and receiving unit 31-3; an input unit 31-4; a display unit 31-5; and an output unit 31-6.

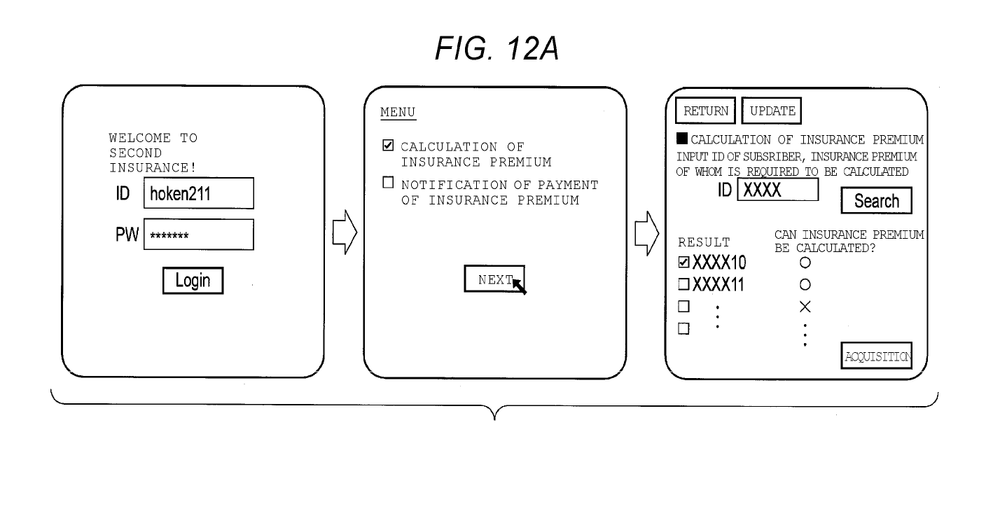

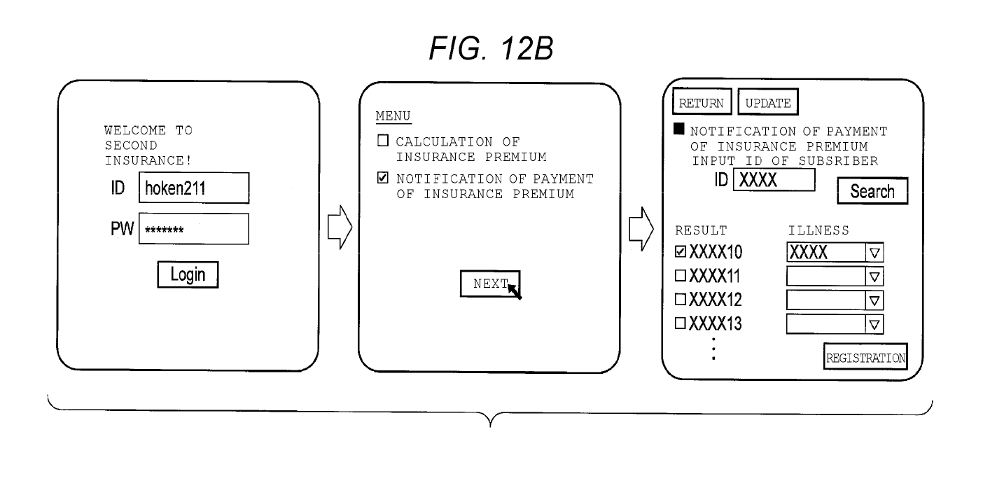

The CPU 31-1 controls the entirety of the life insurance terminal 30-1. When a life insurance company receives a subscription to the first insurance from a user, as illustrated in FIG. 12A, if an employee of the life insurance company starts an application stored in the memory 31-2, and places a request to acquire information regarding a user's rank or an insurance premium via the application (refer to FIG. 12A), the CPU 31-1 transmits a notification, which is indicative of the request being placed, to the first server 20. That is, as illustrated in FIG. 12A, when the employee selects a user, the insurance premium of whom the user wishes to calculate, and pushes an acquisition button, the CPU 31-1 transmits a notification, which is indicative of the request being placed, to the first server 20.

When the life insurance company pays an insurance benefit to a user, the CPU 31-1 transmits a notification, which is indicative of the insurance benefit being paid, to the first server 20 (refer to FIG. 12B). That is, as illustrated in FIG. 12B, when the employee selects a user, the insurance benefit of whom is paid, and pushes a registration button, the CPU 31-1 transmits a notification, which is indicative of the insurance benefit being paid, to the first server 20.

The embodiment is not limited to a case in which only the fact of the insurance benefit being paid is transmitted to the first sever 20, and for example, a flag may be set for the reason of the insurance benefit being paid, and the aforementioned notification may be transmitted along with this flag (refer to FIG. 12B).

When the first server 20 receives the notification indicative of the request being placed, the first server 20 re-calculates the conditions from the difference which is detected based on biological information regarding the user who subscribes to the insurance. Details will be described in a second embodiment.

The memory 31-2 temporarily stores a user's rank or the insurance premium of the user which are calculated by the first server 20. The memory 31-2 also stores a program that reads the user's rank or the insurance premium of the user received from the first server 20.

The transmitting and receiving unit 31-3 receives the user's rank or the insurance premium of the user from the first server 20. When an insurance company pays an insurance benefit to a user, the transmitting and receiving unit 31-3 transmits a notification, which is indicative of the insurance benefit being paid, to the first server 20.

The input unit 31-4 includes a keyboard.

The display unit 31-5 can display the insurance premium of the user calculated by the first server 20.

The output unit 31-6 outputs the insurance premium stored in the memory 31-2. For example, an output operation (printing) is performed by a printer (not illustrated) connected to the life insurance terminal 30-1.

Each of the life insurance terminal 30-1 and the auto insurance terminal 40-1 is not limited to a terminal that includes a housing and a display, and for example, each of the life insurance terminal 30-1 and the auto insurance terminal 40-1 may be a server.

In the embodiment, the first server 20 calculates an insurance premium of a user; however, the embodiment described herein is not limited to that example, and for example, the CPU 31-1 may calculate an insurance premium of a user. Specifically, when the life insurance company receives a subscription to the first insurance from a user, if an employee of the life insurance company starts an application stored in the memory 31-2, and requests information regarding a user's rank via the application, the CPU 31-1 transmits a notification, which is indicative of the request being placed, to the first server 20 along with a user's ID. The first server 20 replies a rank corresponding to the user's ID to the third server 30-2 in response to the notification. The CPU 31-1 calculates an insurance premium based on the rank corresponding to the user's ID which is received via the transmitting and receiving unit 31-3. In this case, the memory 31-2 stores the first table, the second table, and the third table. The CPU 31-1 calculates the insurance premium of the user using the same method by which the first server 20 calculates the insurance premium. The display unit 31-5 displays the calculated insurance premium of the user.

[1-1-7] Third Server 30-2 and Fourth Server 40-2

The third server 30-2 is connected to the life insurance terminal 30-1 via a network. The fourth server 40-2 is connected to the life insurance terminal 40-1 via a network. As described above, when the CPU 31-1 calculates an insurance premium of a user, each of the third server 30-2 and the fourth server 40-2 has a program that calculates an insurance premium from a received user's rank. In addition, each of the third server 30-2 and the fourth server 40-2 includes the first table to the third table, and the like.

### [1-2] Life Insurance Premium

[1-2-1] Regarding Set-Up

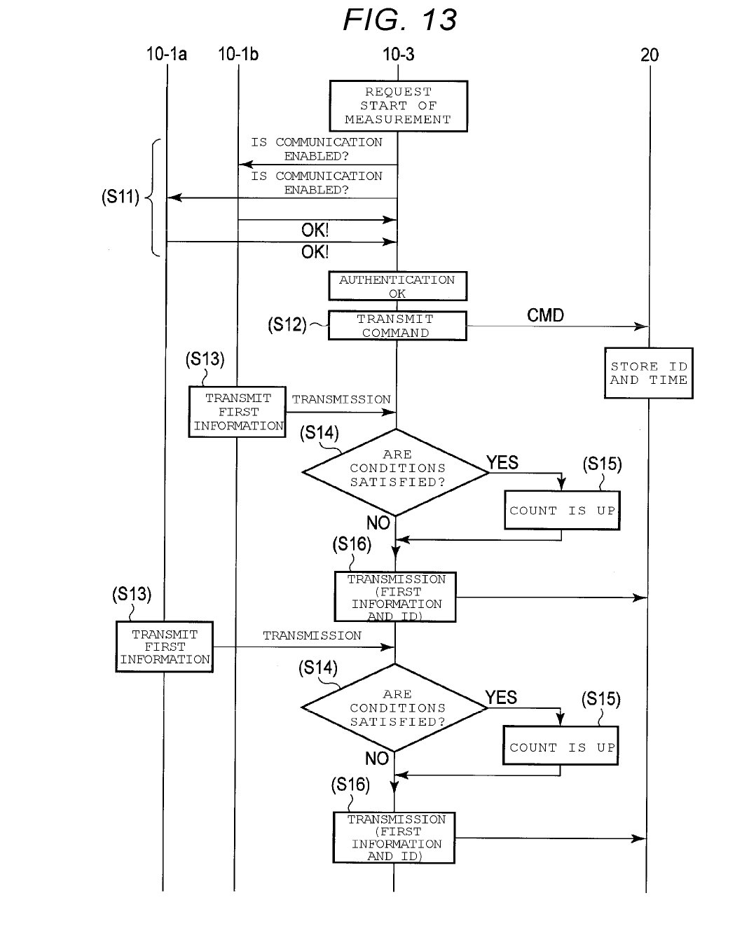

First, biological information regarding a user is required to be collected to calculate a life insurance premium of the embodiment. A set-up to collect biological information will be described with reference to FIG. 13.

In an example to be described in the embodiment, a user wears a first wearable device 10-1a and a second wearable device 10-1b. The first information acquired by the first wearable device 10-1a and the first information acquired by the second wearable device 10-1b are different types of biological information. When it is not necessary to tell the difference between the first wearable device 10-1a and the second wearable device 10-1b, the first wearable device 10-1a and the second wearable device 10-1b are simply referred to as the wearable device 10-1.

When the user starts the application that has been already down-loaded to the communication device 10-3, and inputs a command, which causes to the start of measurement of basic data to calculate an insurance premium, to the communication device 10-3 (refer to FIG. 8B), the communication device 10-3 performs authentication to communicate with the wearable devices 10-1a and 10-1b (S11).

After the authentication for communication can be completed, the communication device 10-3 transmits a command to start measurement, and the like to the first server 20 (S12). When the first server 20 receives this command and the like, the first server 20 stores a user's ID and the time for the start of measurement correlated to each other in the second memory 22-3.

When the wearable device 10-1a is turned on, the communication of the wearable device 10-1a is allowed, and the wearable device 10-1a measures biological information regarding the user, the wearable device 10-1a transmits the first information to the communication device 10-3 (S13). For example, the wearable device 10-1a acquires body temperature waveform data, pulse rate per second, and pulse waveform data regarding the user (S13). Similarly, when the wearable device 10-1b is turned on, the communication of the wearable device 10-1b is allowed, and the wearable device 10-1b measures biological information regarding the user, the first wearable device 10-1b transmits the first information to the communication device 10-3 (S13). For example, the wearable device 10-1b acquires electrocardiographic waveform data, heart rate per second, heartbeat waveform data, acceleration regarding the user.

The communication device 10-3 determines whether items of the first information received from the wearable devices 10-1a and 10-1b satisfy conditions (S14). When the items of the first information satisfy predetermined conditions (Yes in S14), the counter 13-5 of the first server 20 counts up the number of times of getting sick in an illness corresponding to the conditions (S15). When the items of the first information do not satisfy the predetermined conditions (No in S14), the communication device 10-3 proceeds to the subsequent step.

The communication device 10-3 transmits the received first information and the user's ID correlated to each other to the first server 20 (S16). Data stored in the counter 13-5 of the communication device 10-3 may be transmitted to the first server 20. The embodiment described herein is not limited to this case, and when the communication device 10-3 is requested to calculate an insurance premium of an insurance selected by the user, this data may be transmitted to the first server 20.

When the communication device 10-3 has a GPS function, and an electronic payment can be made via the communication device 10-3, the CPU 13-1 of the communication device 10-3 estimates an illness based on the content of the electronic payment. The CPU 13-1 counts the event as user's getting sick in the estimated illness once, and the counter 13-5 stores the illness and the count correlated to each other.

In the embodiment, the communication device 10-3 has a GPS function; however, the embodiment described herein is not limited to a configuration in which the communication device 10-3 has a GPS function, and for example, the wearable devices 10-1a and 10-1b may have a GPS function, the CPU 13-1 may determine a hospital the user attends, based on GPS and map information, count an event as getting an illness associated with the hospital once, may store the illness and the count correlated to each other in the counter 13-5.

[1-2-2] Regarding Step of Calculating Life Insurance Premium

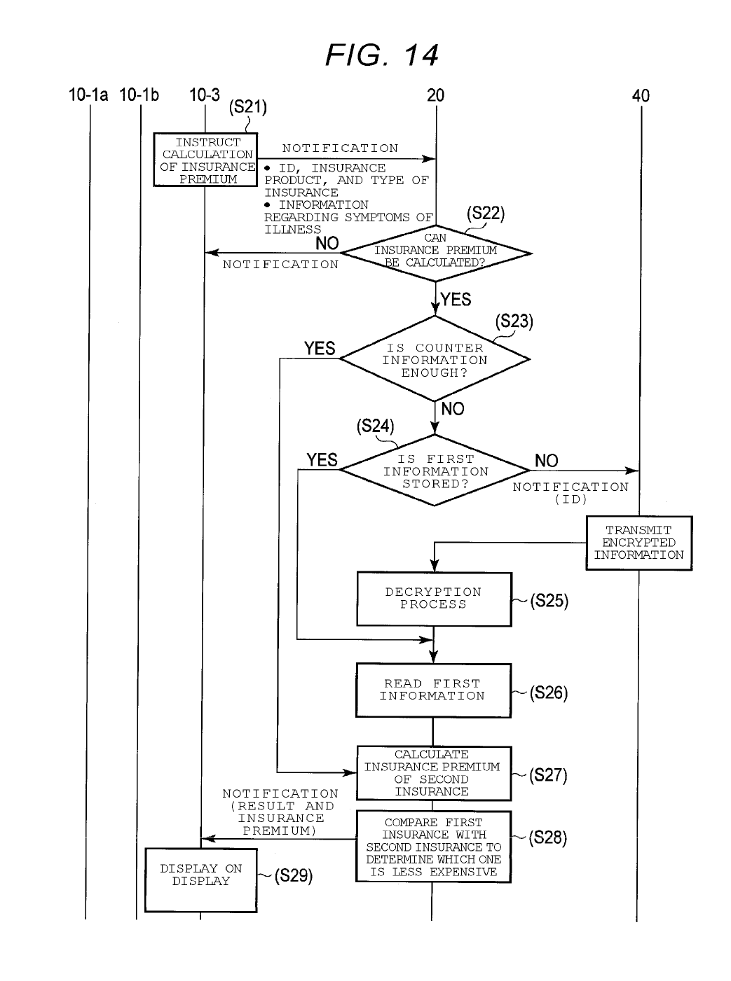

A step of calculating a life insurance premium in the embodiment will be described with reference to FIG. 14.

When a user starts the application, selects the type of an insurance on a screen, the insurance premium of which the user wishes to calculate, and requests the calculation of the insurance premium of the selected insurance (refer to FIG. 8B), the CPU 13-1 of the communication device 10-3 notifies the first server 20 of an instruction to calculate the insurance premium via the transmitting and receiving unit 13-3 (S21).

At this time, the CPU 13-1 controls the transmitting and receiving unit 13-3 of the communication device 10-3 such that information regarding the product content or the type of the selected insurance, a user's ID, information regarding the symptoms of illnesses, a command to request the calculation of the insurance premium, and the like are transmitted to the first server 20. The CPU 22-1 of the first server 20 receives the notification indicative of the calculation of the insurance premium, and determines whether the first server 20 stores the first information over a period required to calculate the insurance premium (S22). Since depending on the type of the selected insurance, the first information necessary is not only changed, but also a necessary period for which the first information is required is changed, the CPU 22-1 reads the necessary period from the first table stored in the first memory 22-2, and determines whether the first server 20 stores the first information over the period required to calculate the insurance premium (S22). When the first server 20 does not store the first information over the necessary period, the first server 20 notifies the communication device 10-3 that the insurance premium of the selected second insurance cannot be calculated (No in S22).

When the insurance premium of the selected second insurance can be calculated (Yes in S22), the first server 20 determines whether the illness which is considerable according to the product content or the type of the selected insurance can be ranked based on the information regarding the symptoms of illnesses which is received from the communication device 10-3 (S23). When the determination can be made (Yes in S23), the process proceeds to step S27. When the determination cannot be made (No in S23), the first server 20 determines whether the first information necessary is stored in the second memory 22-3 (S24).

When the second memory 22-3 stores the first information over the necessary period (Yes in S24), the CPU 22-1 causes the working memory 22-6 to read the first information over the necessary period (S26). When the first server 20 does not store the first information over the necessary period (No in S24), the CPU 22-1 causes the working memory 22-6 to read the first information over the necessary period by acquiring encrypted information from the second server 21, and restoring the encrypted information (S25 and S26).

The first server 20 calculates the insurance premium of the second insurance of the user using the information regarding the symptoms of illnesses which is received from the communication device 10-3, the first information, and the user's ID (S27). A specific method of calculating the insurance premium will be described later.

Subsequently, the first server 20 compares the calculated insurance premium of the second insurance with the insurance premium of the first insurance which is stored in the first memory 22-2 of the first server 20, and thus, determines the insurance premium which is less expensive (S28). The first server 20 transmits the determination result and the insurance premium of the second insurance to the communication device 10-3.

The communication device 10-3 outputs the determination result and the insurance premium of the second insurance to the outside (S29). For example, the display of the communication device 10-3 displays the determination result and the insurance premium of the second insurance. A method of outputting these items of information is not limited to that in the embodiment described herein, and for example, the determination result may be output as a voice message.

When the user subscribes to the second insurance, and the insurance premium of the first insurance is less expensive than that of the second insurance, the display of the communication device 10-3 displays a message that subscription to the first insurance is recommended, and displays the exact deductible difference. When the user subscribes to the second insurance, and the insurance premium of the first insurance is more expensive than that of the second insurance, the display of the communication device 10-3 displays a message that the user is recommended to maintain the subscription to the second insurance, and displays the exact deductible difference in the amount of money between the insurance premium of the second insurance and the insurance premium of the first insurance. When the user does not subscribe to the second insurance, and calculates a provisional insurance premium of the second insurance premium based on the first information and the second information which are measured over a desired period, if the insurance premium of the first insurance is less expensive than the provisional insurance premium of the second insurance, the display of the communication device 10-3 displays a message that the user is recommended not to subscribe to the second insurance. In contrast, if the insurance premium of the first insurance is more expensive than the provisional insurance premium of the second insurance, the display of the communication device 10-3 displays a message that the user is recommended to maintain the subscription to the second insurance, and displays the exact deductible difference in the amount of money between the provisional insurance premium of the second insurance and the insurance premium of the first insurance.

[1-2-3] Regarding Step S27

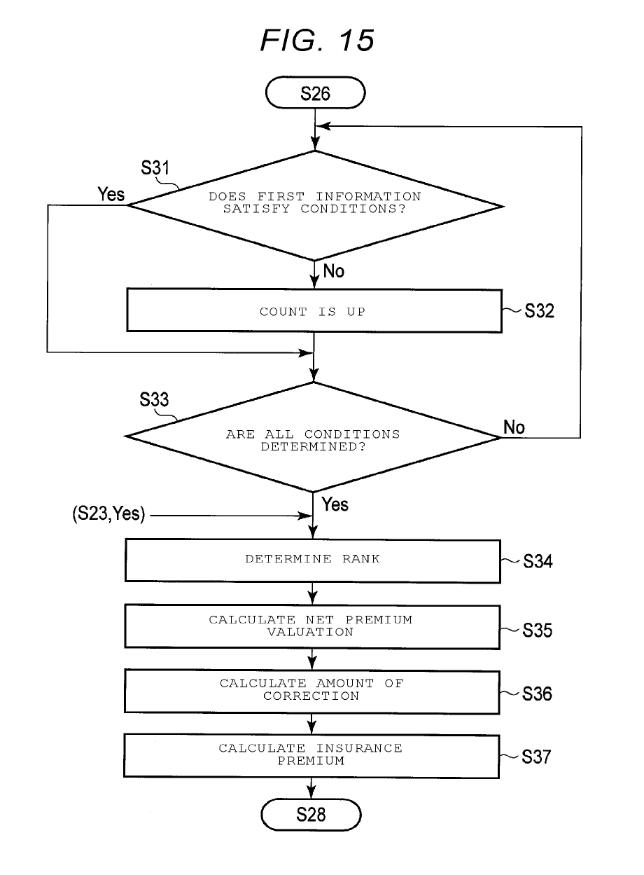

Step S27 in the embodiment will be described with reference to FIG. 15. In the embodiment, the first server 20 calculates the rank of a user, and an insurance premium is calculated based on the rank.

Subsequent to step S26, the CPU 22-1 causes the working memory 22-6 to read the determination conditions of illnesses from the second table, and determines whether the first information read satisfies the determination conditions of the illnesses (S31). For example, when the first information regarding the user satisfies the determination conditions of an illness A twice, and satisfies the determination conditions of an illness B three times, the CPU 22-1 correlates a user's ID to the fact of the conditions of the illness A being met twice, and the illness B being met three times (S32).

In addition, the CPU 22-1 correlates the information regarding the symptoms of illnesses received from the communication device 10-3 to the user's ID (S32).

The CPU 22-1 determines whether the determination on the conditions of an illness which is considerable according to the selected insurance (S33) entirely ends, and when the determination entirely ends (Yes in S33), the process proceeds to step S34. In contrast, when determination does not end entirely (No in S33), the process returns to step S31, and the CPU 22-1 determines whether the first information satisfies the conditions of another illness.

The CPU 22-1 determines the rank of the user (S34). When a result in step S23 is Yes, step S34 is performed with steps S31 to S33 being skipped.

In step S34, the CPU 22-1 converts information regarding the number of times the conditions of each illness correlated to the user's ID are satisfied, and the counter into a grade.

The CPU 22-1 converts illness information regarding all subscribers for the insurance selected by the user into grades using the same algorithm. The CPU 22-1 determines the rank of the user relative to all the subscribers (S34). Illnesses are differently weighted depending on insurance product. For example, in a life insurance, the mortality rate is changed depending on illness. Accordingly, an illness with a high mortality rate is heavily weighted compared to other illnesses (which have a relatively low mortality rate). Illness information is converted into a grade while the severity of illness is weighted. For example, the second memory 22-3 stores a weighting factor. The CPU 22-1 causes the working memory 22-6 to read information regarding the weighting factor, and converts the illness information into a grade using this weighting factor.

The CPU 22-1 calculates a net premium valuation of the selected insurance using the life insurance standard life table (S35). The CPU 22-1 calculates the amount of rise and drop corresponding to the rank of the user from the third table (S36). Specifically, the insurance selected by the user is assumed to determine whether the user gets sick in an illness F more than once over a desired period i. It is assumed that there is no increase in the number of subscribers over the desired period, M is the total number of subscribers, and Ni is the number of subscribers who get sick in the illness F more than once over the desired period (over one year of i years) among all the subscribers. At this time, an insurance premium of a subscriber who gets sick in the illness F more than once over the desired period is P+α which satisfies the following expression. In contrast, an insurance premium of a subscriber who does not get sick in the illness F more than once over the desired period is P−α which satisfies Expression (2) below.

$${\sum }_{i} P * {a}_{i} * {b}_{i} = {\sum }_{i} \{ {( P + α )}_{i} * {N}_{i} + {( P - α )}_{i} * ( M - {N}_{i} ) \} \qquad ( 2 )$$

Here, P represents a net premium valuation, aᵢ represents the number of survivors over i years, and bᵢ represents a present value rate in the beginning of each year over i years.

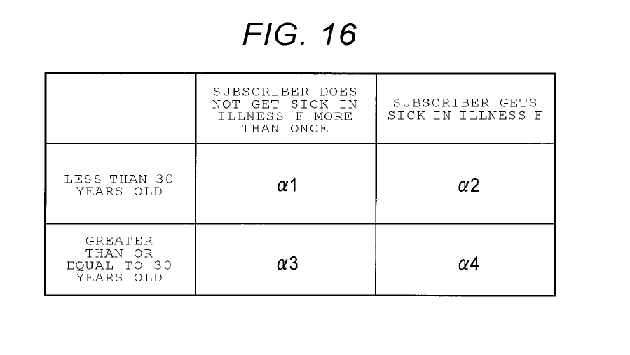

In the embodiment, the CPU 22-1 calculates the amount of rise and drop corresponding to the rank of the user from the third table; however, a method of calculating the amount of rise and drop is not limited to that method in the embodiment, and for example, factors (for example, the age of the user, whether or not the user drives a vehicle, whether or not the user drinks and smokes, and the severity of drinking behavior and smoking behavior) other than the rank may be taken into consideration in calculating the amount of rise and drop. FIG. 16 illustrates a table which is used to calculate the amount of rise and drop based on rank and age. The amount α₁ of rise and drop is applied to an aggregation of users who do not get sick in the illness F and are less than 30 years old. The amount α₂ of rise and drop is applied to an aggregation of users who get sick in the illness F over the desired period and are less than 30 years old. The amount α₃ of rise and drop is applied to an aggregation of users who do not get sick in the illness F and are greater than or equal to 30 years old. The amount α₄ of rise and drop is applied to an aggregation of users who get sick in the illness F over the desired period and are greater than or equal to 30 years old. The values of the amounts α₁ to α₄ of rise and drop are not limited to positive values, and may be negative. The amounts α₁ to α₄ of rise and drop satisfy Expression (3) below.

$${\sum }_{i} P * {a}_{i} * {b}_{i} = {\sum }_{i} \{ {( P + {α}_{1} )}_{i} * {N}_{1} + {( P + {α}_{2} )}_{i} * {N}_{2} + {( P + {α}_{3} )}_{i} * {N}_{3} + {( P + {α}_{4} )}_{i} * ( M - {\sum }_{j = 1}^{3} {N}_{j} ) \} \qquad ( 3 )$$

Here, P represents a net premium valuation, aᵢ represents the number of survivors over i years, and bᵢ represents a present value rate in the beginning of each year over i years. It is assumed that there is no increase or decrease in the number of subscribers over the desired period, M is the total number of subscribers, N₁ is the number of subscribers who are less than 30 years old, and do not get sick in the illness F more than once over the desired period among all the subscribers, N₂ is the number of subscribers who get sick in the illness F more than once over the desired period and is less than 30 years old, and N₃ is the number of subscribers who are greater than or equal to 30 years old, and do not get sick in the illness F more than once over the desired period. Each of the numbers N₁ to N₃ of subscribers is changed every one year of i years; however, each of the numbers N₁ to N₃ of subscribers is used as a reference sign.

As such, the distribution of the insurance premium of the user is changed according to the rank and other factors based on the net premium valuation.

[1-2-4] Regarding Flow of Assigning Rank to User

A process of assigning a rank to a user is a process of determining the position of the user relative to all subscribers for an insurance selected by the user. The rank is changed depending on an increase and decrease in the total number of subscribers for the selected insurance, the type of a weighted illness in the insurance, the health state of each subscriber, and the period taken to calculate an insurance premium. As described above, while the revenues of all companies in the insurance industry are ensured, the insurance premium differentiates between the users according to the health state of each user and other factors based on the net premium valuation. A rise and drop in the rank of a user will be in simple examples hereinbelow. The insurance premium drops with a drop in rank, and the insurance premium rises with a rise in rank.

### Example 1

In an insurance, the number of subscribers over a period ΔT2 is assumed to be increased by X persons relative to the number of subscribers over a period ΔT1. Even if the health state (for example, the number of times a user gets sick in an illness over a period, or the like) of a user remains unchanged over the periods ΔT1 and ΔT2, when the health states of newly subscribed X persons are better than the health state of the user (for example, when the number of times all of the newly subscribed X persons get sick in the illness over the period is less than the number of times the user gets sick in an illness over a period), the rank of the user over the period ΔT2 is higher than that of the user over the period ΔT1. When the health states of newly subscribed X persons are worse than the health state of the user, the rank of the user over the period ΔT2 is lower than that of the user over the period ΔT1. That is, the rank of the user is changed depending on whether a large number of persons are healthier or are not healthier than the user among the newly subscribed X persons.

### Example 2

A weighted illness is changed depending on the type of an insurance selected by a user. The second table stores the types of insurances, the weighting order of illnesses, weighting factors used to convert illness information into grades correlated to each other. When another subscriber gets sick in an illness with a low weighting factor multiple times over a period ΔT, and the user gets sick in an illness with a high weighting factor once, the rank of the user rises.

### Example 3

Rank is changed depending on an increase and decrease in the total number of subscribers for a selected insurance, the types of weighted illnesses in the insurance, the health state of each subscriber, and the period taken to calculate an insurance premium. In Examples 1 and 2, a single variable is changed, and in contrast, actually, a plurality of variables are changed at the same time.

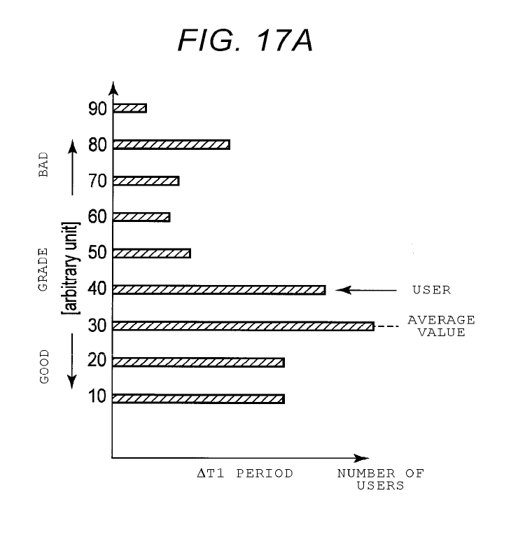

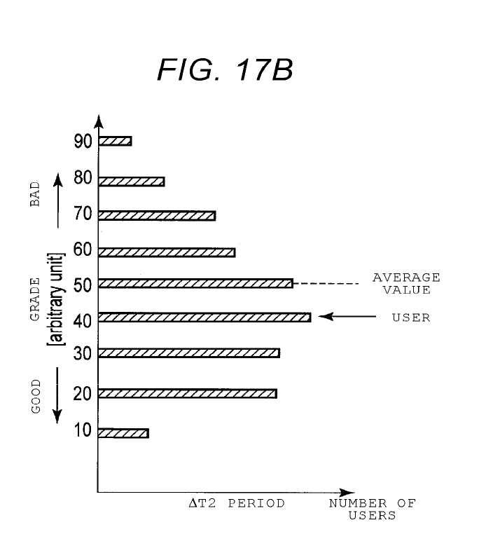

FIG. 17A illustrates the distribution of grades of all subscribers for a selected insurance over the period ΔT1, and FIG. 17B illustrates the distribution of grades of all subscribers for the selected insurance over the period ΔT2. For illustrative purposes, the health state of the user is assumed to become good to the extent that a grade is low.

The average value of the grades of all subscribers over the period ΔT1 is assumed to be 30. The average value of the grades of all subscribers over the period ΔT2 is assumed to be 50. A change in average grade is due to not only an increase and decrease in the total number of subscribers, but also a change in the health state of each subscriber.

When the grade of the user over the period ΔT1 is assumed to be 40, and the grade of the user over the period ΔT2 is assumed to be 40, even if the health state of the user remains unchanged, the rank of the user over the period ΔT2 may drop.

[1-3-1] Auto Insurance Premium Calculation Method

The operation of each system when an auto insurance premium is calculated will be described. An auto insurance premium calculation method is substantially the same as the life insurance premium calculation method, and both methods are different in two points to be described hereinbelow.

(1) The auto insurance premium calculation method is different from the life insurance premium calculation method in that the communication device 10-3 acquires not only the first information from the wearable device 10-1, but also the second information from the vehicle-mounted sensor 10-2. The communication device 10-3 transmits the second information correlated to a user's ID to the first server 20.

(2) The first server 20 not only calculates the position of a user by comparing the first information regarding the user with items of the first information regarding all subscribers for a selected insurance, but also calculates the position of the user by comparing the first information regarding the user boarding a vehicle with the first information regarding the user over periods other than the period for which the user boards the vehicle, and thus, determines the rank of the user based on the two positions of the user.

[1-3-1-1] Regarding Set-Up

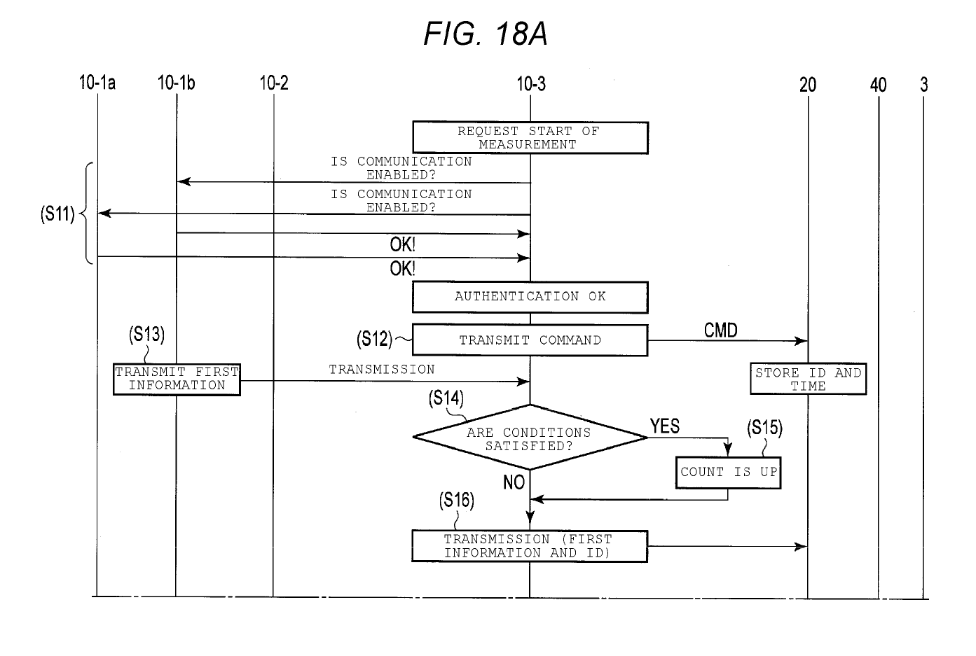

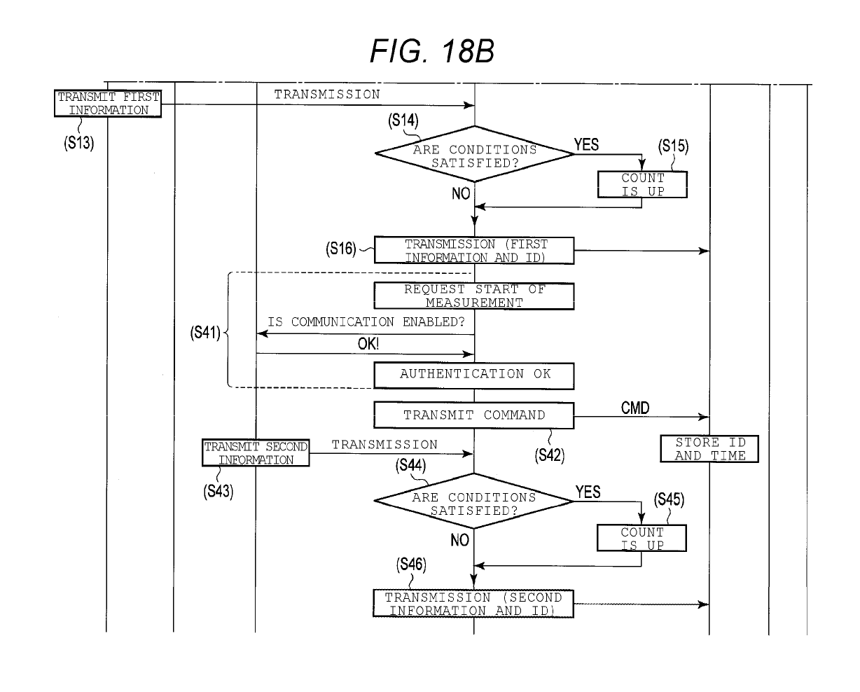

Hereinafter, in calculating an auto insurance premium, a set-up in which the vehicle-mounted sensor 10-2 transmits the second information to the communication device 10-3 will be described with reference to FIGS. 18A and 18B. Detailed descriptions of portions common to FIG. 13 will be omitted.

As illustrated in FIGS. 18A and 18B, when a user starts the application that has been already down-loaded to the communication device 10-3, and inputs a command to start the measurement of basic data (which is required to calculate an insurance premium) to the communication device 10-3 (refer to FIG. 8A), the communication device 10-3 performs authentication to communicate with the vehicle-mounted sensor 10-2 (S41). After the authentication for communication can be completed, the communication device 10-3 transmits a command to start measurement to the first server 20 (S42). When the first server 20 receives this command and the like, the first server 20 stores a user's ID and the time for the start of measurement correlated to each other in the second memory 22-3.

When the vehicle-mounted sensor 10-2 is turned on, the communication of the vehicle-mounted sensor 10-2 is allowed, and the vehicle-mounted sensor 10-2 measures biological information regarding the user and the driving status of a vehicle, the vehicle-mounted sensor 10-2 transmits the second information to the communication device 10-3 (S43).

The communication device 10-3 causes the working memory of the CPU 13-1 to read conditions which are stored in the memory 13-2 to detect an abnormality or change of the vehicle-mounted sensor 10-2, and the CPU 13-1 determines whether the second information satisfies the conditions (S44). Herein, the conditions set to detect an abnormality or change are conditions which are set to detect a situation which is very likely to cause a vehicle accident. Main factors to cause a vehicle accident are meandering driving, drowsy driving, and drunken driving. The memory 13-2 stores conditions set to determine whether a vehicle is a severe meandering driving mode, and the CPU 13-1 determines whether the second information acquired from the vehicle-mounted sensor 10-2 exceeds the conditions (S44). When the second information satisfies the conditions (Yes in S44), the CPU 13-1 cause the counter to count up in response to meandering driving (S45). When the second information does not satisfy the conditions (No in S44), the communication device 10-3 transmits the received second information correlated to the user's ID to the first server 20 (S46).

[1-3-1-2] Regarding Flowchart of when Auto Insurance Premium is Calculated

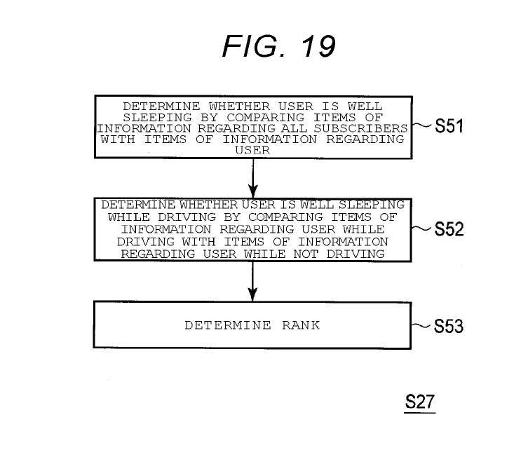

Since a flowchart of when an auto insurance premium is calculated is the same as a flowchart of when a life insurance premium is calculated, only the points of difference will be described with reference to FIG. 19. In the embodiment, in steps S22 to S26 illustrated in FIG. 14, not only the first information but also the second information and counter information regarding the second information are transmitted and received.

In step S27, the first server 20 calculates an auto insurance premium of the second insurance of a user using the information regarding the symptoms of illnesses received from the communication device 10-3, the first information, the second information, the counter information regarding the second information, and the user's ID (S27).

Step S27 will be described in detail with reference to FIG. 19.

The CPU 22-1 determines whether the user is sleeping based on data of all subscribers for an auto insurance selected by the user by comparing the first information and the second information regarding all subscribers with the first information and the second information regarding the user (S51). Specifically, the CPU 22-1 converts drowsiness indexes of all subscribers into grades, and determines whether the user is sleeping based on the distribution of the grades (S51). For example, a method of converting a drowsiness index into a grade is disclosed in U.S. patent application Publication Ser. No. 12/036,740 entitled “APPARATUS AND METHOD FOR MEASURING AUTONOMIC NERVE INDEX AND BIOLOGICAL INFORMATION DETECTING APPARATUS”, filed on Feb. 25, 2008. The entire content of this patent application is incorporated herein by reference.

The CPU 22-1 determines the drowsiness index of the user while the user boards on the vehicle 10A by comparing all of the first information and the second information regarding the user with the first information and the second information regarding the user while boarding in the vehicle 10A (S52). The first server 20 determines the rank of the user using the aforementioned two determinations (S53).

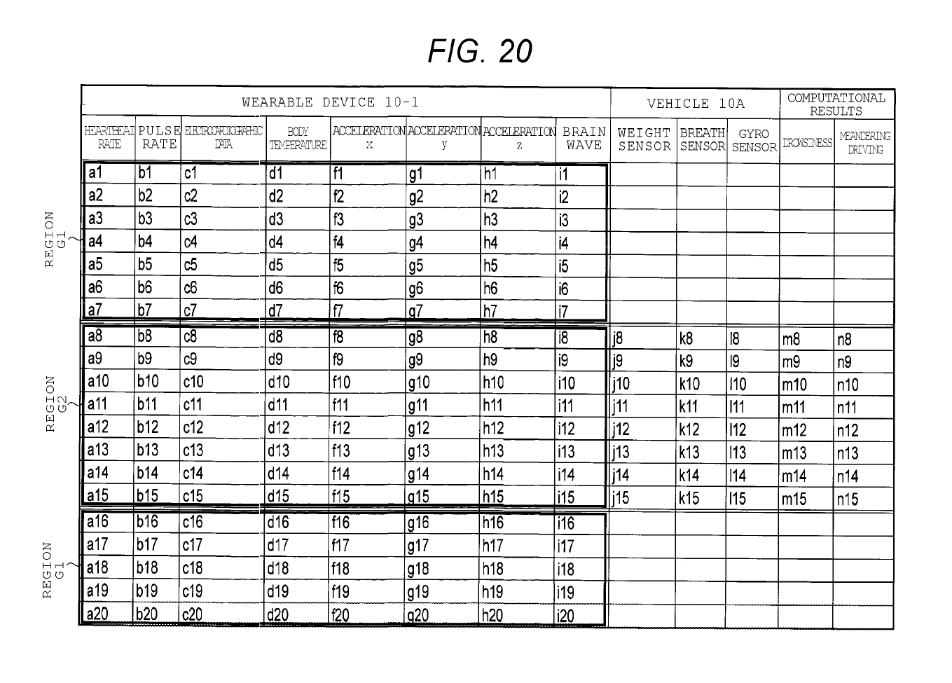

A specific example will be described in detail with reference to FIG. 20. FIG. 20 is a table in which the first information and the second information are correlated to a user' ID. This table is stored in the first server 20 or the second server 21. In FIG. 20, the vertical axis represents time t, and the horizontal axis represents the first information, the second information, and information that is obtained by computing these items of information. The wearable device 10-1 acquires heart rate data, pulse rate data, electrocardiographic data, body temperature data, acceleration x, y, and z data, brain wave data, and the vehicle-mounted sensor 10-2 acquires data from the weight sensor, the breath sensor, and the gyro sensor. The CPU 22-1 of the first server 20 computes data regarding a drowsiness state and a meandering driving state illustrated in FIG. 20 based on the first information and the second information. For illustrative purposes, in FIG. 20, the results of computation are represented as computational results.

The first server 20 or the second server 21 is assumed to store the first information and the second information regarding all subscribers in addition to the user. It is assumed that the value of drowsiness index can be calculated based on the heart rate data, the pulse rate data, the electrocardiogram data, the body temperature data, and the like.

In this case, using data items in a region G1 in a data row in FIG. 20, the CPU 22-1 calculates a value Xⱼ (j is a natural number, and when j=k, Xₖ represents the value of drowsiness index of the user over a period ΔTₖ while not driving) of drowsiness index of the user while not driving. Similarly, using data items in a region G2 in the data row in FIG. 20, the CPU 22-1 calculates a value Yⱼ (j is a natural number, and when j=k, Yₖ represents the value of drowsiness index of the user over the period ΔTₖ while driving) of drowsiness index of the user while driving. Similarly, the CPU 22-1 calculates a value wᵢⱼ (i=the total number of subscribers−1) of drowsiness index of each of all subscribers while not driving.

The CPU 22-1 can understand the positioning of the drowsiness index of the user by calculating first positioning of an average value

$${\sum }_{j} {X}_{i} / j$$

of the distribution of the values wᵢⱼ, and second positioning of an average value

$${\sum }_{j} {X}_{i} / j$$

of the distribution of the values Xⱼ, and multiplying the first positioning by the second positioning.

According to the aforementioned method, the CPU 22-1 understands the positioning of the drowsiness index of the user, and when the user is deeply drowsy while driving, the probability of occurrence of a vehicle accident is deemed to be high, and the positioning of the drowsiness index is used to raise the rank of the user. In contrast, when the user is slightly drowsy while driving, the probability of occurrence of a vehicle accident is deemed to be low, and the positioning of drowsiness index is used to drop the rank of the user.

That is, when a life insurance premium is calculated, the rank of the user is determined by comparing the first information regarding the user with items of the first information regarding all subscribers. In contrast, when an auto insurance premium is calculated, the rank of the user is determined not only by comparing the first information and the second information regarding the user with items of the first information and the second information regarding all subscribers, but also by comparing the first information regarding the user while boarding the vehicle 10A with the first information regarding the user while not boarding the vehicle 10A.

The second information is differently weighted depending on insurance product. The CPU 22-1 causes the working memory 22-6 to read information regarding weighting factors, and converts the weighting factors into grades.

The CPU 22-1 calculates the amount of rise and drop corresponding to the rank of the user from the third table. A method of calculating the amount of rise and drop corresponding to rank is the same as the life insurance premium calculation method, and thus the description of the method of calculating the amount of rise and drop will be omitted.

### [1-4] Method of Displaying on Display

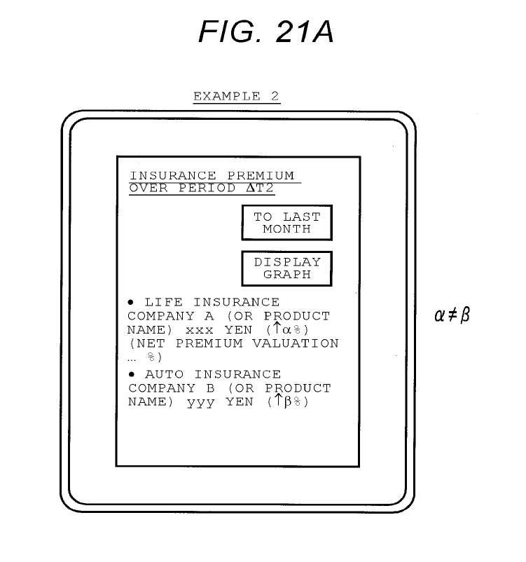

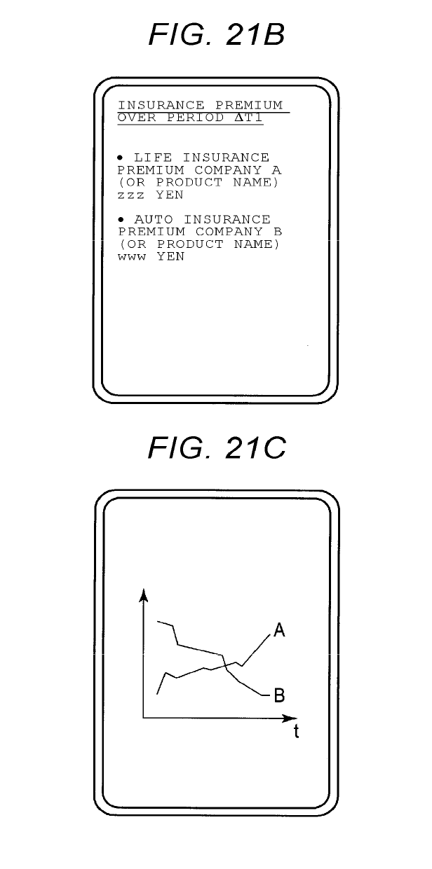

A method of displaying an insurance premium of the second insurance on the display of the communication device 10-3 will be described with reference to FIGS. 21A, 21B, 21C, 22A, 22B, 23A, and 23B.

When a user starts the application, selects the type of an insurance on the screen, the insurance premium of which the user wishes to calculate, and requests the calculation of the insurance premium of the selected insurance, a life insurance premium and an auto insurance premium are displayed on the display.

### Example 1

As illustrated in FIG. 21A, the display displays a life insurance premium and an auto insurance premium over the period ΔT2. Change rates of these life and auto insurance premiums relative to a life insurance premium and an auto insurance premium over the period ΔT1 are displayed. In the embodiment, in the life insurance, the insurance premium over the period ΔT2 rises by a % relative to the insurance premium over the period ΔT1 (refer to FIG. 21A). In the embodiment, a change rate may be represented by the length of arrow on the display. The length of arrow may extend and contract according to the magnitude of the amount of rise and drop in insurance premium. In the auto insurance, the insurance premium over the period ΔT2 rises by β % (in principle, α≠β) relative to the insurance premium over the period ΔT1 (refer to FIG. 21A). The difference between α and β is due to the difference between the method of determining the rank of the user when the life insurance premium is calculated and the method of determining the rank of the user when the auto insurance premium is calculated. Since there is a correlation between the life insurance premium and the auto insurance premium, both of α and β are positive values.

In Example 1, α is different from β; however, α may be equal to β.

The product name or the type of the life insurance or the auto insurance correlated to the insurance premium is displayed (function 1: refer to FIG. 21A). For example, when ΔT1 is one month, the past insurance premiums for the last month, the before last month, and the like can be referenced (function 2: refer to FIG. 21B). The life insurance premium and the auto insurance premium can be displayed as time series data (function 3). In addition, the transition of each of the life insurance and the auto insurance can be graphically illustrated with the vertical axis representing an insurance premium and the horizontal axis representing a period (function 4: refer to FIG. 21C). A change rate of the net premium valuation of each of the life insurance and the auto insurance may be displayed (function 5: refer to FIG. 21A). The aforementioned functions 1 to 5 can be applied to Example 2 and the subsequent examples.

### Example 2

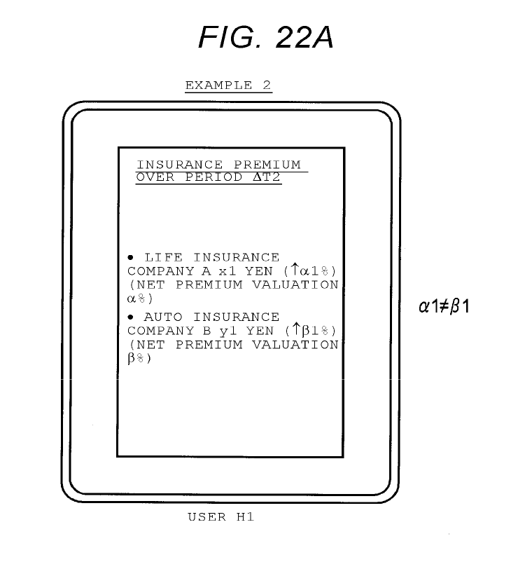

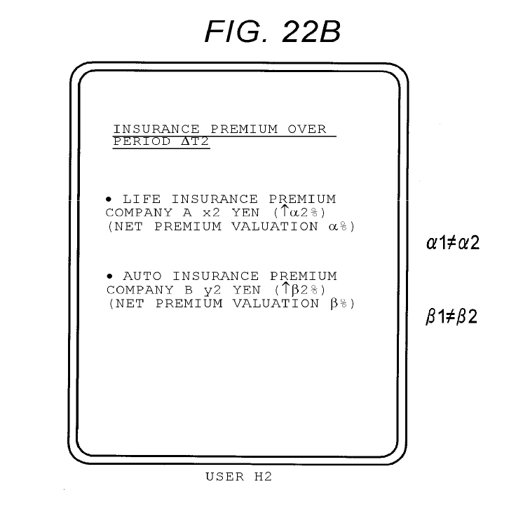

A case in which a plurality of users are present will be described. For the purpose of simplifying a description, a case in which a user H1 and a user H2 are present will be examined. FIG. 22A illustrates the display of the communication device 10-3 of the user Hi, and FIG. 22B illustrates the display of the communication device 10-3 of the user H2.

In the embodiment, the display of the communication device 10-3 of the user Hi displays that the insurance premium over the period ΔT2 rises by α1 % relative to the insurance premium over the period ΔT1 in a life insurance. In an auto insurance, the insurance premium over the period ΔT2 rises by β1 % (in principle, α1≠β1) relative to the insurance premium over the period ΔT1. The display of the communication device 10-3 of the user H2 displays that the insurance premium over the period ΔT2 rises by α2 % relative to the insurance premium over the period ΔT1 in the life insurance. In the auto insurance, the insurance premium over the period ΔT2 rises by β2 (in principle, α2≠β2) relative to the insurance premium over the period ΔT1.

Example 2 is different from Example 1 in that α1 is different from α2, and β2 is different from β1. The reason for this is that the health state of each of the users H1 and H2 is reflected in the insurance premium. If the two users H1 and H2 are only subscribers for an insurance, when α1 is a positive value, α2 is a negative value, and when α1 is a negative value, α2 is a positive value. Similarly, the positive and negative signs of β1 and β2 are reversed. Since there is a correlation between the life insurance premium and the auto insurance premium, the positive and negative signs of α1 are the same as those of β1, and the positive and negative signs of α2 are the same as those of β2.

Similar to Example 1, α1 is different from β1, and α2 is different from β2; however, α1 and α2 may be equal to β1 and β2, respectively.

### Example 3

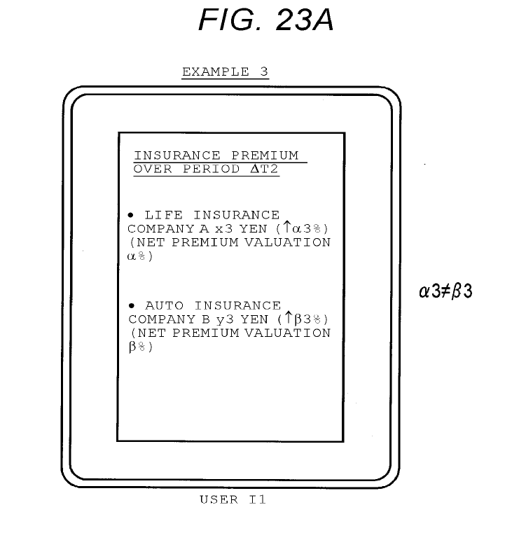

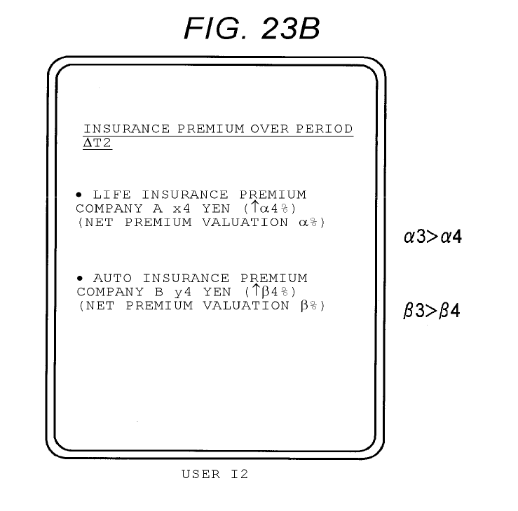

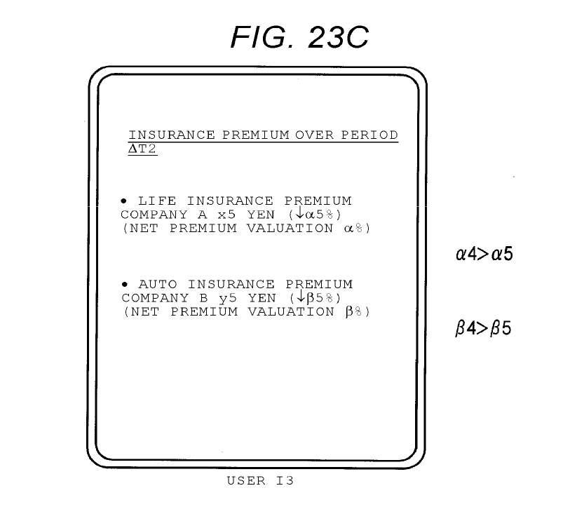

Similar to Example 2, a case in which a plurality of users are present will be described. For the purpose of simplifying a description, a case in which a user I1, a user I2, and a user 13 are present will be described. FIG. 23A illustrates the display of the communication device 10-3 of the user I1, FIG. 23B illustrates the display of the communication device 10-3 of the user I2, and FIG. 23C illustrates the display of the communication device 10-3 of the user I3. The user I1 is assumed to be a person who already got sick in acute cardiac syndromes (ACS), the user I2 is assumed to be a person who does not get sick acute cardiac syndromes, but is very likely to get sick in acute cardiac syndromes (ACS) in the future, and the user I3 is assumed to be a person who gets a cold.

In the embodiment, the display of the communication device 10-3 of the user I1 displays that the insurance premium over the period ΔT2 rises by α3 % relative to the insurance premium over the period ΔT1 in the life insurance. In the auto insurance, the insurance premium over the period ΔT2 rises by β3 % (in principle, α3≠β3) relative to the insurance premium over the period ΔT1. The display of the communication device 10-3 of the user I2 displays that the insurance premium over the period ΔT2 rises by α4 % relative to the insurance premium over the period ΔT1 in the life insurance. In the auto insurance, the insurance premium over the period ΔT2 rises by β4 (in principle, α4≠β4) relative to the insurance premium over the period ΔT1. The display of the communication device 10-3 of the user I3 displays that the insurance premium over the period ΔT2 drops by α5 % relative to the insurance premium over the period ΔT1 in the life insurance. In the auto insurance, the insurance premium over the period ΔT2 drops by β5 (in principle, α5ββ5) relative to the insurance premium over the period ΔT1. Example 3 is different from Example 2 in that α3 is greater than α4, and β3 is greater than β4. The reason for this is that the mortality rate of the user I1 is higher than that of the user I2. In addition, the difference between α3 and α4 is less than the difference between α3 and α5, and the difference between α4 and α5. The reason for this is that the users I1 and I2 are in more proximate relationship than a relationship between the users I1 and I3 and a relationship between the users I2 and I3, and thus a change rate of the insurance premium of the user I1 is proximate to that of the user I2. That is, the reason for this is that the rank of the user I1 is proximate to that of the user I2 compared to proximity between the ranks of the users I1 and I3, and proximity between the ranks of the users I2 and I3.

Similar to Example 1, α3 is different from β4, α5 is different from β5, and α6 is different from β6; however, α3, α5, and α6 may be equal to β4, β5, and β6, respectively.

### Example 4

Example 4 is based on the same assumption as in Example 3. When users die of acute cardiac syndromes in many cases, it is possible to set α3 and α4 to rise rates which are higher than that of a user who gets sick in another illness. Information is displayed on the display in the same manner as in Example 3.

Hereinafter, an outline of a relationship between the display methods of the displays in Examples 1 to 4 and the concept of the embodiment will be given.

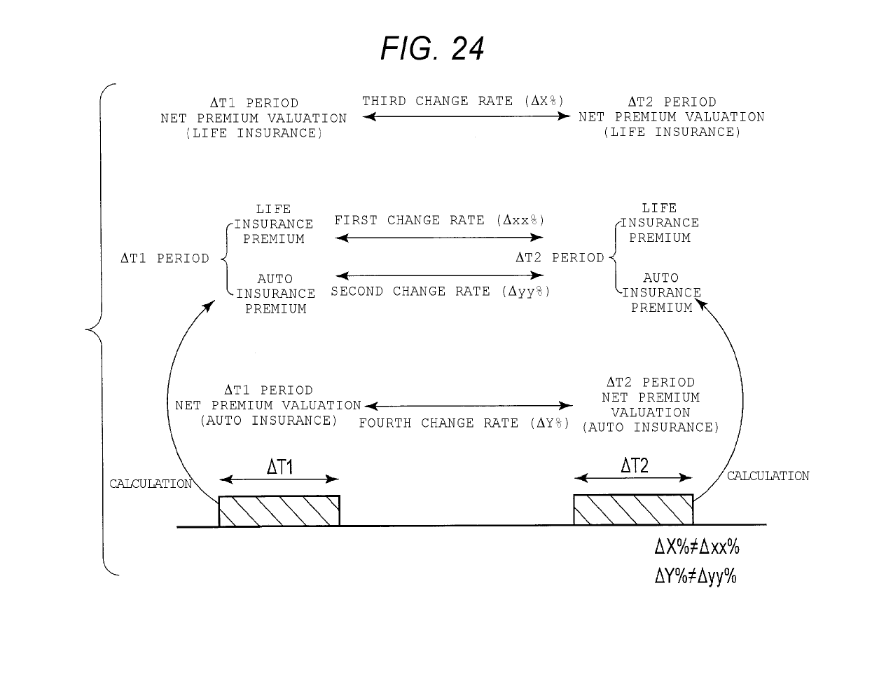

As illustrated in FIG. 24, a life insurance premium and an auto insurance premium over the period ΔT1 are calculated based on the first information and the second information regarding the user over the period ΔT1. A life insurance premium and an auto insurance premium over the period ΔT2 are calculated based on the first information and the second information regarding the user over the period ΔT2 (which is different from the period ΔT1). A first change rate (Δ xx %) is a change rate of the life insurance premium over the period ΔT2 relative to the life insurance premium over the period ΔT1. A second change rate (Δ yy %) is a change rate of the auto insurance premium over the period ΔT2 relative to the auto insurance premium over the period ΔT1. A third change rate (Δ X %) is a change rate of a net premium valuation (the life insurance) over the period ΔT2 relative to a net premium valuation (life insurance) over the period ΔT1. A fourth change rate (Δ Y %) is a change rate of a net premium valuation (the auto insurance) over the period ΔT2 relative to a net premium valuation (the auto insurance) over the period ΔT1. The first change rate is different from the third change rate. The reason for this is that biological information regarding the user and the like are reflected in the first change rate. Similarly, the second change rate is different from the fourth change rate. The reason for this is that biological information regarding the user and the like are reflected in the second change rate. In addition, in principle, the first change rate is different from the second change rate. When a life insurance premium is calculated, the rank of the user is determined by comparing the first information regarding the user with items of the first information regarding all subscribers. In contrast, when an auto insurance premium is calculated, the rank of the user is determined not only by comparing the first information and the second information regarding the user with items of the first information and the second information regarding all subscribers, but also by comparing the first information regarding the user while boarding the vehicle 10A with the first information regarding the user while not boarding the vehicle 10A.

### [1-5] Effects of First Embodiment and the Like

According to the first embodiment, it is possible to obtain the following (1) to (3).

(1) A user can collectively manage insurance premiums to be paid to an insurance company, and can collectively reduce any of the insurance premiums.

In the embodiment, there is a correlation between a life insurance premium and an auto insurance premium, and each of the insurance premiums is calculated based on biological information regarding the user.

Effects of the embodiment will be described in comparison of the embodiment with a comparative example in which there is no correlation between a life insurance and an auto insurance. In the comparative example, a user is required to understand a characteristic of each insurance so as to reduce the total amount of a life insurance premium and an auto insurance premium. However, in the embodiment, since there is a correlation between the life insurance premium and the auto insurance premium, the user can simply reduce the total amount of the life insurance premium and the auto insurance premium without understanding a characteristic of each insurance. In addition, since the user can recognize a change rate of the insurance premium over a period relative to the insurance premium over the last period, the user can easily analyze factors and causes induced by the change rate. Accordingly, in comparison of the embodiment with the comparative example, the user can collectively manage the insurance premiums to be paid to the insurance company, and can collectively reduce any of the insurance premiums, and the configuration in the embodiment is user friendly.

(2) It is possible to guide a user to maintain and improve a health state.

In response to a user's demand, the display of the communication device 10-3 displays a life insurance premium and an auto insurance premium in which the health state of the user is reflected. The user can become aware of their health state. According to the insurance premium calculation method in the embodiment, an insurance premium drops when the health state of the user is better than before, or the health states of others, and thus it is possible to guide the user to improve and maintain their health state.

(3) An insurance company can reduce the risk of an insurance benefit being paid to a user.

In the embodiment, there is a correlation between a life insurance premium and an auto insurance premium, and each of the insurance premiums is calculated based on biological information regarding the user. In the comparative example, the analysis of risks of each of the life insurance and the auto insurance is required, and thus risk management may not become easy. However, in the embodiment, the insurance company can collectively manage the life insurance premiums and the auto insurance premiums, and thus can simply manage risks.

When the health state of each user is getting better as described in (2), a morality rate is reduced. As a result, the insurance company can reduce the amount of money to be paid as an insurance benefit.

### [2] Second Embodiment

In the first embodiment, conditions (including the conditions of the first information and the conditions of the second information) used to determine the rank of a user are set conditions, and the conditions which are set once remain unchanged until an administrator of the first server 20 sets new conditions in the first server 20. However, in a second embodiment, the conditions are not changed to new conditions which are set by the administrator of the first server 20. The conditions are computed based on the first information and the second information of the user, and items of the first information and the second information of all subscribers, and are automatically updated not via the administrator.

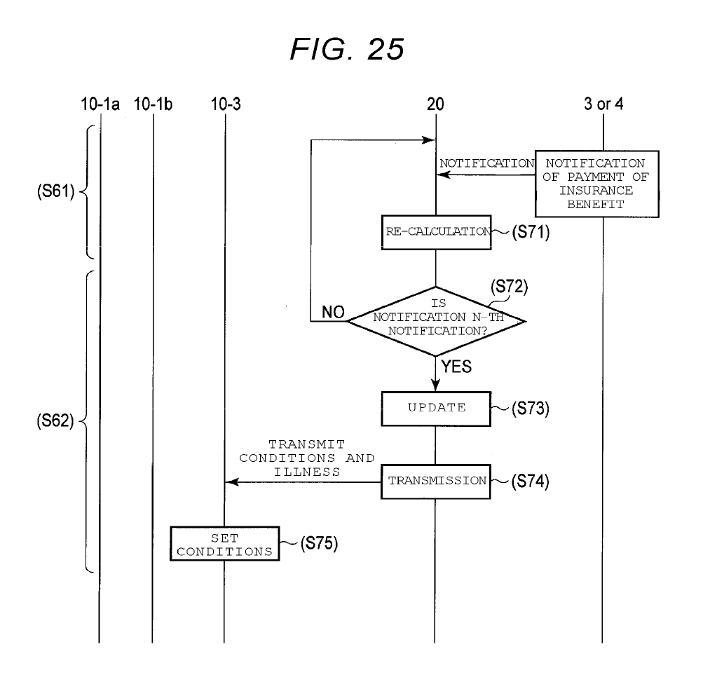

As illustrated in FIG. 25, when the first server 20 receives a notification, which is indicative of an insurance benefit being paid to the user, from the third system 3 or the fourth system 4, the first server 20 re-calculates conditions (S61), and when the first server 20 receives notifications, which are indicative of insurance benefits being paid to users, from the third system 3 or the fourth system 4 a total of n times (n is a natural number, and n≧2), the first server 20 automatically updates the conditions based on the difference of each user (S62). The embodiment described herein is not limited to a case in which the first server 20 receives a notification from the third system 3 or the fourth system 4, and when a subscriber gets sick in an illness, that is, when the counter of the communication device 10-3 counts up, the communication device 10-3 may transmit a notification, which is indicative of the occurrence of that event, to the first server 20, and the first server 20 may receive the notification, and update the conditions.

### [2-1] Re-Calculation Flow (S61)

As illustrated in FIG. 25, when the first server 20 receives a notification, which is indicative of an insurance benefit being paid to a user, from the third system 3 or the fourth system 4, the first server 20 re-calculates the conditions (S71). Specifically, when the first server 20 receives the notification, the first server 20 causes the working memory 22-6 to read the first information and the second information required for re-calculation. When the first server 20 does not store the first information and the second information which are necessary, the first server 20 reads from and restores encrypted information from the second server 21.

For example, when an average pulse rate of a user over a predetermined period before a notification is received is α6 beats per second, and the average pulse rate of the user over the predetermined period after the notification is received is α7 beats per second, the first server 20 sets the conditions of the user to a “change from α6 beats per second to α7 beats per second”. A method of evaluating biological information is not limited to an evaluation method that is based on the averaging of parameter values, and for example, biological information may be evaluated based on the averaging and distribution of parameter values.

The first server 20 may re-calculate conditions whenever the first server 20 receives a notification for each user (S71). The CPU 22-1 stores the re-calculated conditions of the user in the first memory 22-2. The first memory 22-2 stores the conditions correlated to a user's ID and the type of an illness. For example, the first memory 22-2 stores acute cardiac syndromes (ACS), a user J1, and the change of an average pulse rate from α6 beats per second to α7 beats per second, all of which are correlated to each other. This data is referred to as individual conditions.

### [2-2] Flow for Updating Conditions (S62)

A flow for updating conditions will be described with reference to FIG. 25.

In an example to be given hereinafter, the first server 20 re-calculates conditions at each time of a total of n times the first server 20 receives notifications, which are indicative of insurance benefits being paid due to an illness K, from the third system 3 or the fourth system 4. For the purpose of simplifying a description, insurance benefits are assumed to be paid to n persons. Step 1 for each notification is assumed to have been already completed.

When the first server 20 receives the notifications a total of n times (Yes in S72), the first server 20 updates the conditions (S73). Step S73 will be described in detail. First, the first server 20 causes the working memory 22-6 to read individual conditions, which are calculated in step 1, from the first memory 22-2.

As conditions, the CPU 22-1 determines common points between the differences of the individual conditions which are detected based on items of biological information regarding n persons. A specific example will be described later. When there are no common points present between all the differences which are detected based on items of biological information regarding n persons, the differences are grouped together, and the difference of a group including the greatest numbers of users is determined as the conditions. That is, the difference of a group including a majority of users is determined as the conditions.

The first server 20 transmits the conditions correlated to the illness K to the communication devices 10-3 of all subscribers for the insurance along with commands (S74). Each of the communication devices 10-3 receives data of the conditions and the illness K, and updates the conditions of the illness K stored in the memory 13-2 (S75). When the conditions of the illness K are not set in the communication device 10-3 before the communication device 10-3 receives the data of the conditions and the illness K, the communication device 10-3 adds to and stores the conditions of the illness K in the memory 13-2.

When the communication device 10-3 receives the first information and the second information from the wearable device 10-1 and the vehicle-mounted sensor 10-2, and the first information and the second information satisfy the conditions set in the communication device 10-3, the counter 13-5 of the CPU 13-1 counts up the number of times of getting sick in the illness K.

In the embodiment, each of the communication devices 10-3 updates the conditions of the illness K stored in the memory 13-2; however, the embodiment is not limited to a case in which the conditions of the illness K stored in the memory 13-2 are updated, and for example, when a characteristic of biological information of a user considerably deviates from characteristics of items of biological information of all subscribers, the first server 20 may transmit the individual conditions calculated in step S61 to the communication device 10-3 of the user instead of the conditions calculated in step S62. In this case, the individual conditions of the user are set in the memory 13-2 of the communication device 10-3 of the user. One example is a case in which a user got sick in the illness K in the past, and the individual conditions of the user are different from conditions calculated in step S62.

### [2-3] Method of Determining Conditions

A specific example of a method of determining conditions will be described.

α8 to α9 is assumed to be a change rate of average pulse rates of a1 persons among n persons over a predetermined period before the receipt of notifications relative to those of a1 persons over the predetermine period after the receipt of the notifications. β1 to β2 (α8<β1<β2<α9) is assumed to be a change rate of average pulse rates of a2 persons among n persons over the predetermined period before the receipt of notifications relative to those of a2 persons over the predetermine period after the receipt of the notifications. γ1 to γ2 (β1<γ1<γ2<β2) is assumed to be a change rate of average pulse rates of the remaining persons over the predetermined period before the receipt of notifications relative to those of the remaining persons over the predetermine period after the receipt of the notifications.

In this case, the first server 20 calculates the change rate γ1 to γ2, which is common to all of n persons, as the difference of biological information. The conditions of the illness K are determined to be that a change rate of an average pulse rate from the period ΔT1 to the period ΔT2 is γ1 to γ2.

When there are no common points present between all the differences which are detected based on items of biological information regarding n persons, the differences are grouped together, and the difference of a group including the greatest numbers of users is determined as the conditions. That is, the difference of a group including a majority of users is determined as the conditions.

Hereinafter, a specific example will be described. α8 to α9 is assumed to be a change rate of average heart rates of a1 persons among n persons over a predetermined period before the receipt of notifications relative to those of a1 persons over the predetermine period after the receipt of the notifications. β1 to β2 (α8<β1<β2<α9) is assumed to be a change rate of average heart rates of a2 persons among n persons over the predetermined period before the receipt of notifications relative to those of a2 persons over the predetermine period after the receipt of the notifications. γ1 to γ2 is assumed to be a change rate of average heart rates of a3 persons among n persons over the predetermined period before the receipt of notifications relative to those of a3 persons over the predetermine period after the receipt of the notifications. It is assumed that the differences of the remaining persons cannot be detected. The sum of a1 and a2 is assumed to be greater than a3.

In this case, the first server 20 groups the differences. When there are common points present between at least portions of the differences, the first server 20 categorizes the differences into the same group. In the aforementioned example, though the range of the change rates of the average pulse rates of a1 persons is different from that of the average pulse rates of a2 persons, (a1+a2) persons have the same change rate β1 to β2. Accordingly, the first server 20 extracts two change rates as candidate conditions as follows: (1) the change rate β1 to β2 of the average pulse rates over the predetermined period before the receipt of notifications relative to those over the predetermined period after the receipt of the notifications, and (2) the change rate γ1 to γ2 of the average heart rates over the predetermined period before the receipt of notifications relative to those over the predetermined period after the receipt of the notifications.

The first server 20 determines candidate conditions, under which a large number of users are present, as the conditions between both of the candidate conditions. In the aforementioned example, since the sum of a1 and a2 is greater than a3, the candidate conditions (1) are determined as the conditions.

The conditions are calculated by statistically processing items of the first information and the second information of the subscribers for the insurance. The statistical processing in the embodiment is not limited to statistical processing based on only an average value, and for example, an averaging and distribution technique is used, and an overlapping portion in the distribution may be determined as common points.

### [2-4] Effects of Second Embodiment

According to the second embodiment, it is possible to obtain not only the same effects as in the first embodiment, but also the following effects (4) and (5).

(4) An insurance company can estimate the health state of a user, and easily manage risks.

In the first embodiment, the communication device 10-3 detects conditions having a correlation with an illness, and an insurance company manages risks. That is, in the first embodiment, due to a direct causal relationship between an illness and conditions, when the communication device 10-3 detects that the conditions from the first information and the second information regarding a user are satisfied, the user is very likely to already got sick in the illness, or to get sick in the illness in the near future, and thus there is a short amount of time available until risks are reduced.

However, in the embodiment, conditions (including the conditions of the first information and the conditions of the second information) used to determine the rank of a user are calculated based on the first information and the second information regarding the user, and items of the first information and the second information regarding all subscribers.

That is, in the embodiment, conditions do not necessarily have a direct causal relationship with an illness, and the communication device 10-3 can more quickly detect that the user is very likely to get sick in the illness than the first embodiment. As a result, the insurance company easily manages risks compared to the first embodiment.

(5) An insurance company can more accurately manage risks according to a characteristic of each user.

In the second embodiment, different conditions for each user are set in the communication device 10-3 depending on whether the user got sick in an illness in the past. Accordingly, even if a characteristic of biological information regarding a user considerably deviates from characteristics of items of biological information regarding all subscribers, the insurance company can accurately manage risks.

### [3] Third Embodiment

In a life insurance and an auto insurance, in the first and second embodiments, the first insurance and the second insurance are present, and in contrast, a description of the embodiment is given based on the assumption that only the second insurance is present.

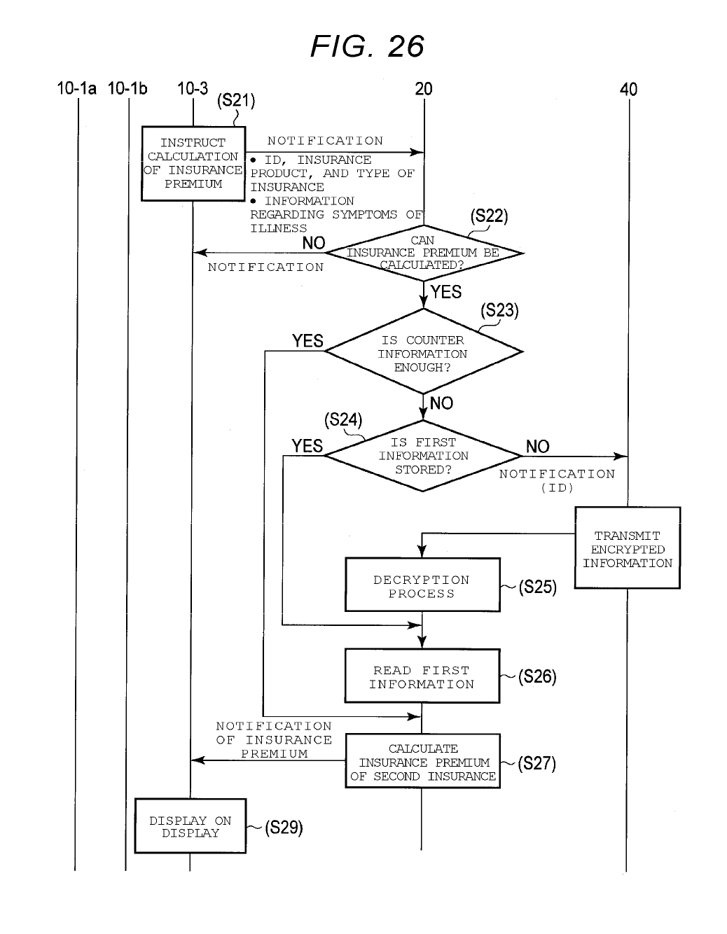

In this case, as illustrated in FIG. 26, the step “in which the CPU 22-1 compares an insurance premium of the first insurance with an insurance premium of the second insurance” is omitted unlike the first and second embodiments. Accordingly, the CPU 22-1 transmits the insurance premium of the second insurance to the communication device 10-3.

In the third embodiment, it is possible to obtain the same effects as in the first and second embodiments.

### [4] Fourth Embodiment

In the first embodiment, when a life insurance company pays an insurance benefit to a user, the third system 3 or the fourth system 4 places a notification, which is indicative of the insurance benefit being paid to the user, to the first server 20 via a network, and in contrast, in this embodiment, the wearable devices 10-1a and 10-1b detect an event (the death of a user in a life insurance) when an insurance benefit is to be paid. The event when an insurance benefit is to be paid implies not only the death of a user, but also that a user is hospitalized when an insurance company pays hospital charges or the like in an accident insurance.

### [4-1] Method of Detecting Event when Insurance Benefit is to be Paid

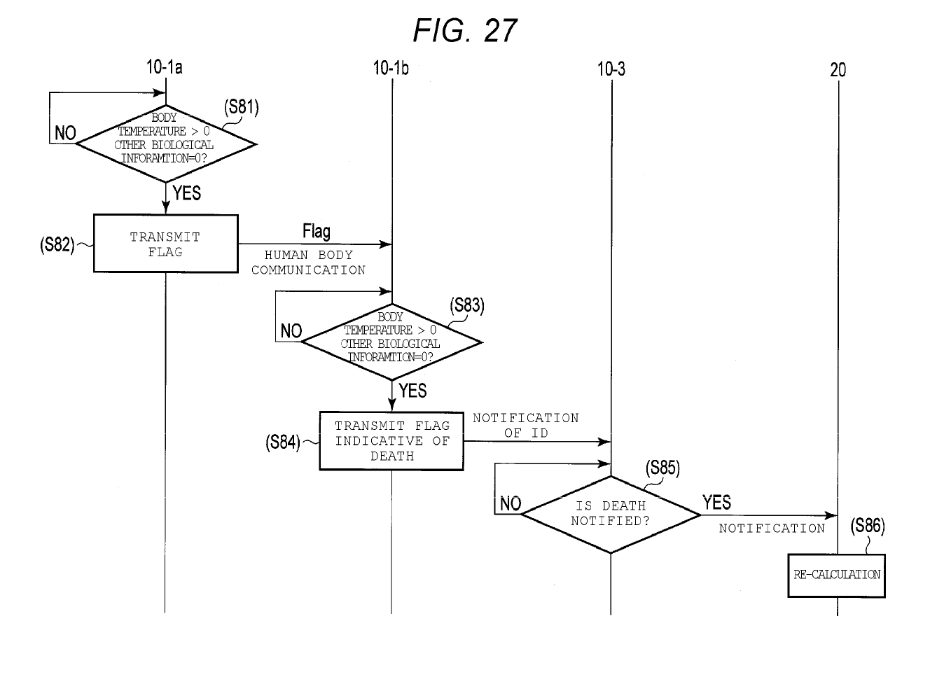

Hereinafter, a specific example will be described with reference to FIG. 27.

Both of the wearable devices 10-1a and 10-1b are assumed to be able to detect the body temperature of a user. When the wearable device 10-1a detects a positive body temperature of the user, and cannot detect other items of biological information (for example, a pulse rate) (Yes in S81), the wearable device 10-1a outputs a first flag to the wearable device 10-1b (S82). Communication therebetween is performed using human body communication.

When the wearable device 10-1b detects a positive body temperature of the user, and cannot detect other items of biological information (for example, a pulse rate), and then the wearable device 10-1b receives the first flag from the wearable device 10-1a (Yes in S83), the wearable device 10-1b transmits a notification, which is indicative of the occurrence of an event when an insurance benefit is to be paid to the user, to the communication device 10-3 (S84). In contrast, when a positive body temperature of the user and other items of biological information (for example, a pulse rate) can be detected (No in S83), the wearable device 10-1b waits until receiving the first flag from the wearable device 10-1a again.

When the communication device 10-3 receives the notification, the communication device 10-3 transmits the notification indicative of the insurance benefit being paid to the user, and a user's ID to the first server 20 (S85). The first server 20 receives the notification, and acquires biological information in a range of time before and after the receipt of the notification. The subsequent steps are the same as in the first embodiment. The first server 20 re-calculates and determines conditions (S86).

### [4-2] Effects of Fourth Embodiment

According to the fourth embodiment, it is possible to not only obtain the same effects as in the first embodiment, but also the following effect (6).

(6) An insurance company can quickly detect whether an event when an insurance benefit is to be paid occurs with a user, and can easily manage risks.

In the embodiment, the wearable device 10-1a communicates with the wearable device 10-1b using human body communication, and thus the enablement of communication therebetween implies that the wearable devices 10-1a and 10-1b are in contact with the user. In addition, the fact that the wearable device 10-1 detects a positive body temperature of the user, and cannot detect other items of biological information (for example, a pulse rate) implies that an event when an insurance benefit is to be paid occurs with the user.

In the first embodiment, the fact that the first server 20 does not acquire a notification, which is indicative of an insurance benefit being paid to a user, from the third system 3 or the fourth system 4 does not imply that an event when an insurance benefit is to be paid occurs with the user. Typically, there is a considerable amount of time delay between the occurrence of an event when an insurance benefit is to be paid to a user, and a notification indicative of the occurrence of the event, and it may be not easy to accurately calculate conditions.

However, in the embodiment, a notification cannot be obtained from the third system 3 or the fourth system 4, and a notification from the communication device 10-3 is received in real time, and thus it is possible to considerably reduce a time delay between the occurrence of an event when the insurance benefit is to be paid to the user, and a notification indicative of the occurrence of the event, and it is possible to accurately calculate conditions. Accordingly, the insurance company can easily manage risks compared to the first embodiment.

### [5] Fifth Embodiment

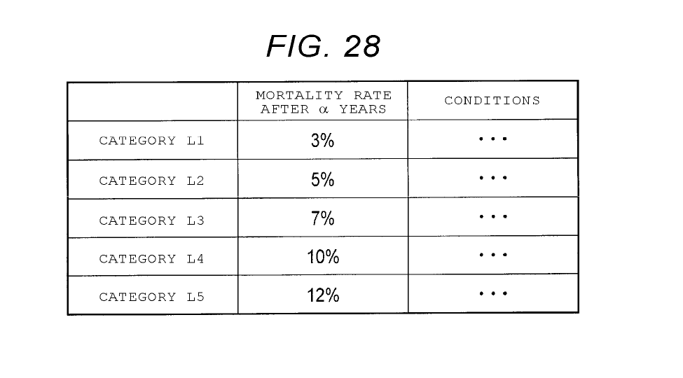

In the first to third embodiments, it is determined whether the first information and the second information regarding a user satisfy the conditions corresponding to an illness, and the rank of the user is calculated using the determination result as one variable, and in contrast, in this embodiment, it is not determined whether the conditions of an illness are satisfied, and the rank of a user is calculated by determining conditions having a correlation with the death of a user from the first information and the second information received from the user as one variable, and using the conditions as one variable. For example, the first memory 22-2 stores a table illustrated in FIG. 28. In this table, users are categorized according to the mortality rates of the users, and the conditions of items of “the first information and the second information” of users are correlated to the mortality rate for each category.

In FIG. 28, L1 represents a category for a mortality rate of 3% after a years, L2 represents a category for a mortality rate of 5% after a years, L3 represents a category for a mortality rate of 7% after a years, L4 represents a category for a mortality rate of 10% after a years, and L5 represents a category for a mortality rate of 12% after a years. The conditions to be detected are different between the categories. In the embodiment, the first server 20 calculates the rank of a user using this table.

### [5-1] Method of Setting Conditions

In a method of setting conditions in the embodiment, similar to the method of determining conditions in [2-3], first, the first server 20 calculates the difference based on the first information and the second information regarding each user. In an example to be given hereinafter, the first server 20 receives notifications, which are indicative of insurance benefits being paid due to an illness L1, from the third system 3 or the fourth system 4 n times. In this example, it is assumed that the number of subscribers for an insurance is X, and an insurance company pays insurance benefits to n persons among the subscribers.

Similar to the “method of determining conditions” in [2-3], the first server 20 extracts common points between the differences, and the differences are grouped into a plurality of categories.

In a specific description using the example illustrated in [2-3], (a1+a2) persons among n persons satisfy conditions (1), and a3 persons satisfy conditions (2).

(1) β1 to β2 is a change rate of an average pulse rate over a predetermined period before the receipt of a notification relative to the average pulse rate over the predetermined period after the receipt of the notification.

(2) γ1 to γ2 is a change rate of an average heart rate over the predetermined period before the receipt of a notification relative to the average heart rate over the predetermined period after the receipt of the notification.

Accordingly, the first server 20 groups users, the change rate of whom satisfies the conditions (1), into the category L1, groups users, the change rate of whom satisfies the conditions (2), into the category L2, sets the mortality rate of users in the category L1 to (a1+a2)/X*100 (=3%), and sets the mortality rate of users in the category L2 to a3/X*100 (5%).

As a result, the first server 20 generates a table in which the conditions (1) and (2) are correlated to the morality rates.

### [5-2] Rank Calculation Method

When the first server 20 receives the first information and the second information regarding a user from the communication device 10-3, the first server 20 determines the category of the user. When the category of the user is determined, the first server 20 calculates the rank of the user using the morality rate as one variable. Instead of calculating the rank of the user, the first server 20 may calculate an insurance premium of the user in the category by adding the amount of rise and drop, which satisfies Expression (4) below, to a net premium valuation.

It is assumed that two categories are present, the morality rate of the category L1 is 3%, the morality rate of the category L2 is 5%, and the amount of rise and drop for the user in the category L1 is α₁.

$${\sum }_{i} P * {a}_{i} * {b}_{i} = {\sum }_{i} \{ {( P + {α}_{1} )}_{i} * {N}_{1} + {( P + {α}_{1} * \frac{5 \%}{3 \%} )}_{i} * {N}_{2} + {( P + {α}_{2} )}_{i} * ( M - {\sum }_{j = 1}^{2} {N}_{j} ) \} \qquad ( 4 )$$

Here, P represents a net premium valuation, aᵢ represents the number of survivors over i years, and bᵢ represents a present value rate in the beginning of each year over i years. The number of users in a category A is assumed to be N₁, and the number of users in a category B is assumed to be N₂. The number N₁ of users and the number N₂ of users are changed every one year of i years; however, the number N₁ of users and the number N₂ of users are reference signs.

At this time, an insurance premium of the user in the category L1 is P+α₁, and an insurance premium of the user in the category L2 is P+α₁*(5%/3%).

### [5-3] Effects of Fifth Embodiment

According to the fifth embodiment, it is possible to obtain not only the same effects as in the first embodiment, but also the following effect (7).

(7) It is possible to early calculate an insurance premium without calculating conditions of an illness compared to the first to third embodiments.

### [6] Sixth Embodiment

In a sixth embodiment, a company such as a beverage producer, or an individual (hereinafter, who is also referred to as an advertiser) can advertise their products or services to users in a health state to whom the advertiser wishes to advertise their products or services. The display of a user displays advertisements of an advertiser. The things to be displayed are not limited to an advertisement, and for example, advices on the health state of the user may be displayed. Both of advertisements and advices may be displayed. Hereinafter, a specific example will be described.

### [6-1] Regarding Operation of First Server 20

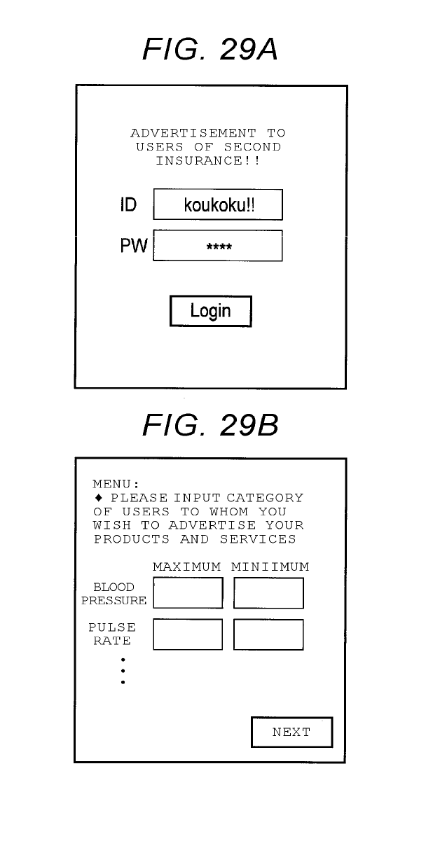

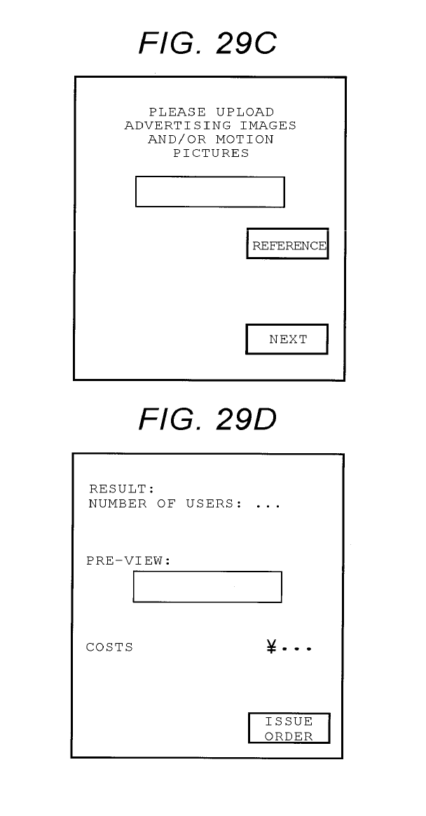

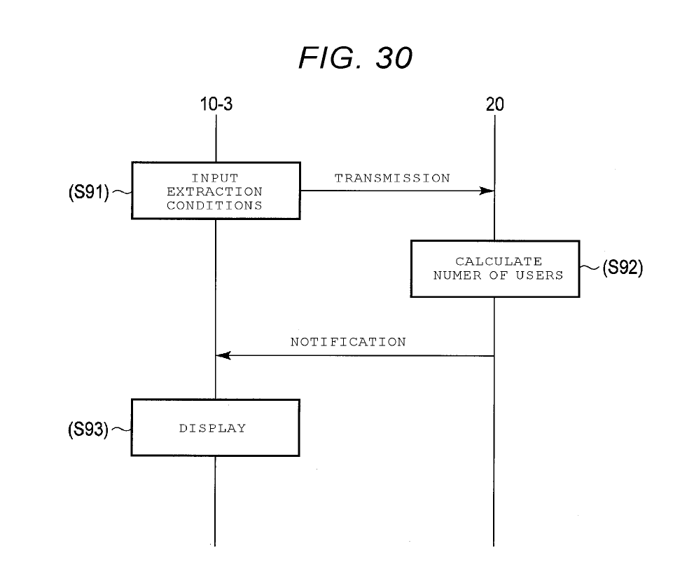

The operation of the first server 20 will be described with reference to FIG. 30. An advertiser installs an application on communication device 10-3 thereof, and starts the application (refer to FIG. 29A). As illustrated in step S91 in FIG. 30, the advertiser inputs conditions for extracting users, to whom the advertiser wishes to advertise their products or services, via the application (refer to FIG. 29B). For example, when a beverage producer wishes to advertise their products to users who have a peak-to-peak blood pressure difference which is less than 30, the advertiser inputs the extraction conditions that the peak-to-peak blood pressure difference is less than 30. Thereafter, the communication device 10-3 of the advertiser notifies the first server 20 of the extraction conditions. As illustrated in step S92 in FIG. 30, the first server 20 receives the notification, and calculates the number of subscribers for an insurance, first conditions and second conditions of whom coincide with the extraction conditions.

The first server 20 notifies the communication device 10-3 of the advertiser the number of users, the conditions of whom coincide with the extraction conditions. When the advertiser uploads images and/or motion pictures, which the advertiser wishes to advertise on the communication device 10-3, via the application (refer to FIG. 29C), as illustrated in step S93 in FIG. 30, the display of the communication device 10-3 displays the images and/or the motion pictures, the number of users, the conditions of whom coincide with the extraction conditions, and costs (refer to FIG. 29D).

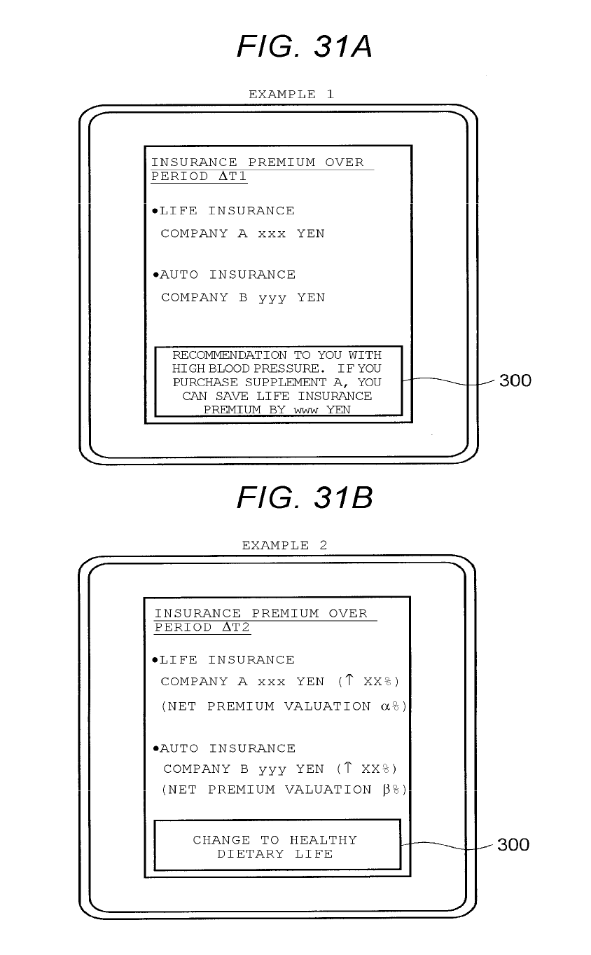

When the advertiser confirms the content of the display, and places an order via the application, a notification of the order being placed is transmitted from the communication device 10-3 of the advertiser to the first server 20. The first server 20 transmits the advertisements of the images and/or the motion pictures to the communication devices 10-3 of the users, the conditions of whom coincide with the extraction conditions. As a result, as illustrated in FIGS. 31A and 31B, an advertisement 300 is displayed on the display of the communication device 10-3 of each user.

### [6-2] Regarding Display of Advertisement on Display

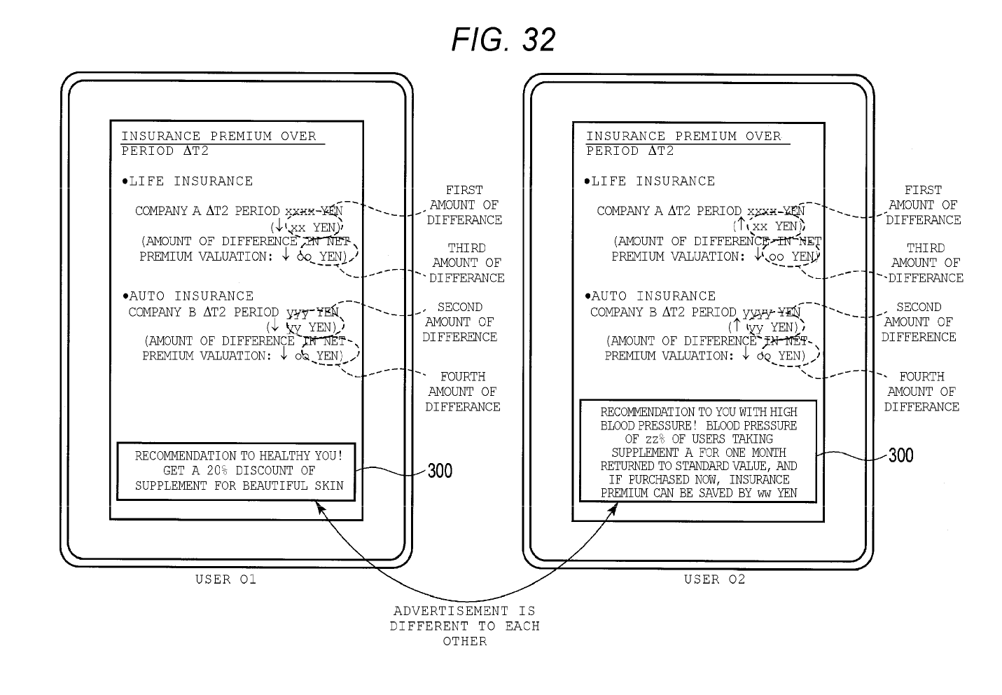

As illustrated in FIG. 32, when advertisements are made by a plurality of advertisers, extraction conditions are different between the advertisers. Accordingly, advertisements displayed on the communication devices 10-3 of two users may be different.

Insurance premiums (a life insurance premium and an auto insurance premium) are displayed on the display of the communication device 10-3 of each of users O1 and O2, and the advertisement 300 is displayed at the bottom of a screen.

The advertisement 300 that “Recommendation to healthy you!, and get a 20% discount of a supplement for beautiful skin” is displayed on the communication device 10-3 of the user O1.

The advertisement 300 that “Recommendation to you with a high blood pressure!, the blood pressure of zz % of users taking a supplement A for one month returned to a standard value, and if purchased now, an insurance premium can be saved by ww yen” is displayed on the communication device 10-3 of the user O2.

### [6-3] Effects of Sixth Embodiment

According to the sixth embodiment, it is possible to obtain not only the same effects in the first embodiment, but also the following effect (8).

(8) An advertiser can advertise their products or services to only users with buying intention, and can improve advertisement efficiency.

(9) A user is promoted to maintain or improve their health state owing to advices on their health state, and can easily reduce an insurance premium.

(10) An insurance company can promote a user to maintain or improve their health state, and reduce a risk of an insurance benefit being paid to a user.

### [7] Seventh Embodiment

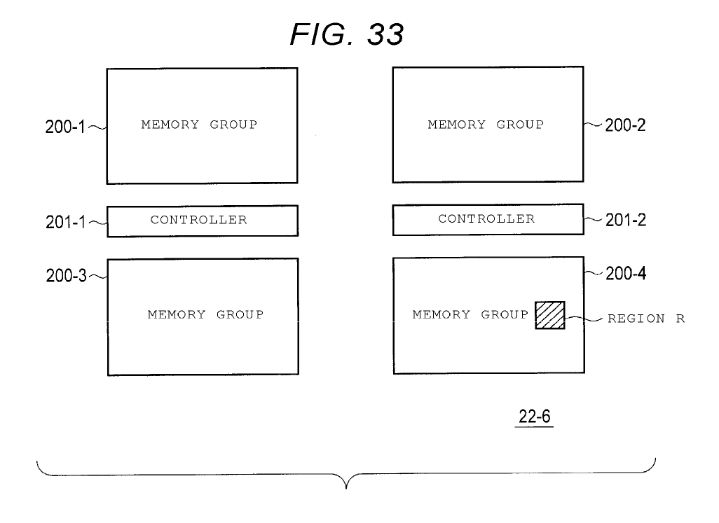

In a seventh embodiment, the working memory 22-6 will be described with reference to FIGS. 33 to 35. A memory port is an example of the configuration of the working memory 22-6 used to realize the services in the aforementioned embodiments. A specific configuration is disclosed in U.S. patent application Publication Ser. No. 14/023,901 entitled “STORAGE DEVICE AND STORAGE METHOD”, filed on Sep. 11, 2013, and U.S. patent application Publication Ser. No. 13/729,633 entitled “METHOD OF PROCESSING DATABASE, DATABASE PROCESSING APPARATUS, COMPUTER PROGRAM PRODUCT”, filed on Dec. 28, 2012. The entire contents of these patent applications are incorporated herein by reference.

### [7-1] Working Memory 22-6

As illustrated in FIG. 33, the working memory 22-6 includes a plurality of memory groups 200-1 to 200-4 (when it is not necessary to tell the difference therebetween, which are simply referred to as a memory group 200), and controllers 201-1 and 201-2 (when it is not necessary to tell the difference therebetween, which are simply referred to as a controller 201) for controlling the memory group 200.

[7-1-1] Memory Group 200

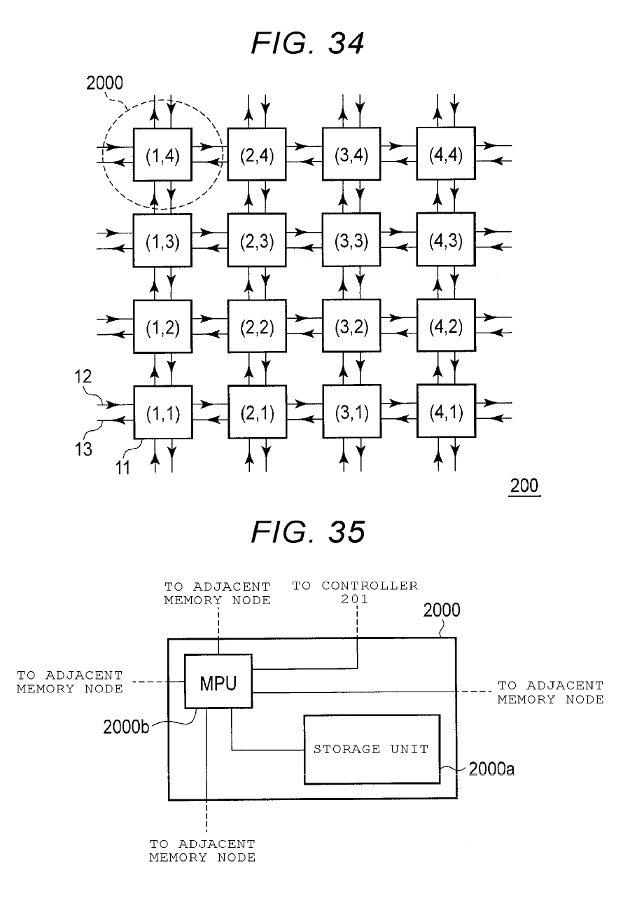

As illustrated in FIG. 34, the memory group 200 includes a plurality of memory ports 2000. The memory ports 2000 are disposed in a matrix pattern along row and column directions. The memory ports 2000 are electrically connected to each other via data buses which allow data to be transmitted and received therebetween.

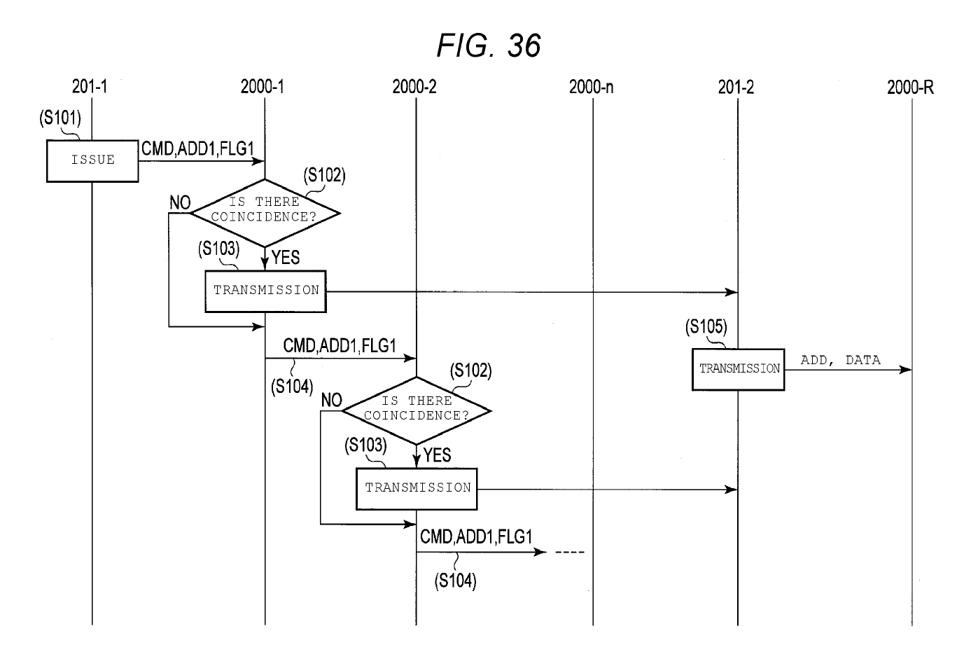

As illustrated in FIG. 35, the memory port 2000 includes a storage unit 2000a and an MPU 2000b.

The storage unit 2000a can store data. For example, a NAND type flash memory is used as the storage unit 2000a. For example, a memory cell array is disclosed in U.S. patent application Publication Ser. No. 12/407,403 entitled “THREE DIMENSIONAL STACKED NONVOLATILE SEMICONDUCTOR MEMORY”, filed on Mar. 19, 2009. In addition, a memory cell array is disclosed in U.S. patent application Publication Ser. No. 12/406,524 entitled “THREE DIMENSIONAL STACKED NONVOLATILE SEMICONDUCTOR MEMORY”, filed on Mar. 18, 2009, U.S. patent application Publication Ser. No. 12/679,991 entitled “NON-VOLATILE SEMICONDUCTOR STORAGE DEVICE AND METHOD OF MANUFACTURING THE SAME”, filed on Mar. 25, 2010, and U.S. patent application Publication Ser. No. 12/532,030 entitled “SEMICONDUCTOR MEMORY AND METHOD FOR MANUFACTURING SAME”, filed on Mar. 23, 2009. The entire contents of these patent applications are incorporated herein by reference.

The MPU 2000b controls the storage unit 2000a. An MPU 2000b receives a transmission command CMD, a data type FLG1, and a transmission destination address ADD1, and when a data type stored in the storage unit 2000a coincides with the received data type FLG1, the MPU 2000b transmits the data of the storage unit 2000a to the transmission destination address ADD1.

[7-1-2] Controller 201

The operation of the controller 201-1 will be described.

For example, in order to compute conditions in the first to sixth embodiments, the controller 201-1 may extract items of biological information necessary from the first information and the second information, and compute the items of extracted biological information. At this time, the controller 201-1 computes the treated biological information multiple times. The controller 201-1 is very unlikely to be able to perform computational processes at a high speed to the extent that the frequency of computation and the amount of biological information used in computation are increased.

In the embodiment, in order to prevent an increase in the frequency of reading biological information to be treated in every computation, the controller 201-1 extracts items of biological information used in computation at once, and moves the items of biological information to a region at once. Thereafter, the controller 201-1 performs computation using the items of biological information extracted.

A specific method will be described with reference to FIG. 36.

For example, in order to compute conditions, the controller 201-1 is assumed to move items of biological information regarding the heart-beats of all subscribers for an insurance to a region R. In this case, the controller 201-1 transmits the transmission command CMD, the data type FLG1, and the transmission destination address ADD1 to the memory ports of the memory groups 200-1 and 200-3 (S101). The transmission destination address ADD1 referred to here includes a leading address of the memory ports in the region R, and the address of a controller which manages the leading address.

When a memory port receives the transmission command CMD, the data type FLG1, and the transmission destination address ADD1, the MPU 2000b determines whether a data type stored in the storage unit 2000a coincides with the received data type FLG1 (S102). When the data type stored in the storage unit 2000a coincides with the received data type FLG1, the MPU 2000b transmits the data of the storage unit 2000a to the transmission destination address ADD1 (S103). Specifically, the data of the storage unit 2000a included in the transmission destination address ADD1 is transmitted to the controller 201-2 via another memory port 2000. The transmission command CMD, the data type FLG1, and the transmission destination address ADD1 are transmitted to the subsequent memory port 2000 (S104). When a data type stored in the storage unit 2000a does not coincide with the received data type FLG1, the transmission command CMD, the data type FLG1, and the transmission destination address ADD1 are transmitted to the subsequent memory port 2000 (S104). A transmission destination is the controller 201-2 that manages the memory ports in the region R.

Whenever the controller 201-2 receives biological information regarding heartbeat, the controller 201-2 sequentially specifies an address of the region R again, and transmits the biological information to the memory ports in the region R (S105).

After the biological information is stored in the region R, the controllers 201-1 and 201-2 compute conditions.

### [7-2] Effects of Seventh Embodiment

According to the seventh embodiment, even if the frequency of computation or the amount of biological information used in computation is increased, items of biological information used in computation are collected in the region Rat once. For this reason, it is possible to compute data items stored in the region R, and it is not necessary to read biological information to be treated in every computation.

As a result, it is possible to prevent an increase in the frequency of reading biological information to be treated in every computation.

### [8] Eighth Embodiment

In the first to seventh embodiments, it is assumed that a user V1 subscribes to an insurance, and the first information and the second information are transmitted from the communication device 10-3 to the first server 20. In this case, there is a possibility that the user V1 gets a user V2, who does not subscribe to the insurance, to wear the wearable device 10-1, and calculates an insurance premium. At this time, the first information received from the wearable device 10-1 is the first information regarding the user V2, and thus an ID of the user V1 is correlated to the first information and the second information regarding the user V2.

### [8-1] Authentication Method

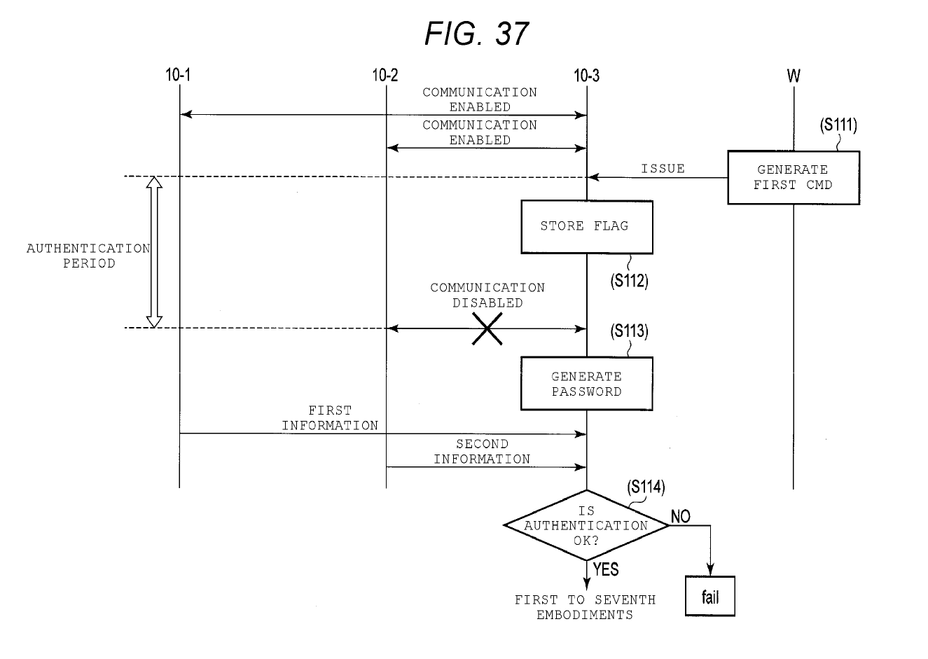

In the eighth embodiment, in order to prevent such spoofing, the following authentication method is used. Specifically, the authentication method will be described with reference to FIG. 37.

When the communication device 10-3 of the user V1 communicates with the wearable device 10-1 of the user V1, and the first information and the second information from the communication device 10-3 are received, an authentication device issues a first command to the communication device 10-3 (S111).

An authentication period refers to a period from when the communication device 10-3 receives the first command to until the communication device 10-3 stops receiving the first information and the second information. The first information and the second information received by the communication device 10-3 during the authentication period are the first information and the second information regarding the legitimate user V1. The communication device 10-3 stores a flag indicating that the received first information and second information are the first information and the second information regarding the legitimate user V1 (S112). After the elapse of the authentication period, the CPU 11-1 generates a password based on the first information and the second information which are received during the authentication period (S113). For example, the password is the inherent characteristics of the first information and the second information regarding a user. The password is not necessarily a numeral, and for example, is a part of a pulse waveform or an electrocardiographic waveform. The embodiment described herein is not limited to a case in which a password is generated based on one item of biological information, and for example, a portion of a plurality of items of biological information may be used to generate a password.

When the communication device 10-3 receives the first information and the second information from the wearable device 10-1 and the vehicle-mounted sensor 10-2 after the expiration of the authentication period, the CPU 11-1 determines whether the first information and the second information received after the expiration of the authentication period are the first information and the second information regarding the user V1 using the password (S114). That is, the CPU 11-1 causes the working memory to read the first information and the second information received after the expiration of the authentication period, and determines whether the received first information and second information include the inherent characteristics of the user (S114). When the received first information and second information include the inherent characteristics of the user (Yes in S114), the CPU 11-1 determines that the received first information and second information are the first information and the second information regarding the user V1. When the received first information and second information do not include the inherent characteristics of the user (No in S114), the CPU 11-1 determines that the received first information and second information are not the first information and the second information regarding the user V1.

When the CPU 11-1 determines that the received first information and second information are the first information and the second information regarding the user V1 (Yes in S114), each system operates as in the first to seventh embodiments. When the CPU 11-1 determines that the received first information and second information are not the first information and the second information regarding the user V1 (No in S114), each system does not operate as in the first to seventh embodiments, measurement does not start until re-authentication is performed.

### [8-2] Effects of Eighth Embodiment

According to the eighth embodiment, when the communication device 10-3 of the user V1 communicates with the wearable device 10-1 of the user V1, and the first information and the second information from the communication device 10-3 are received, the authentication device issues the first command to the communication device 10-3. For this reason, it is possible to prevent such spoofing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising a display, the display being capable of showing a first insurance premium of a first insurance and a second insurance premium of a second insurance, the first insurance being different from the second insurance, and the second insurance premium rises when the first insurance premium rises.

2. The communication device according to claim 1, wherein the display is capable of showing a first net premium valuation of the first insurance and a second net premium valuation of the second insurance, the first net premium valuation being different from the second net premium valuation.

3. The communication device according to claim 1, wherein the first insurance is a life insurance and the second insurance is an auto insurance.

4. The communication device according to claim 1, wherein the second insurance premium drops when the first insurance premium drops.

5. The communication device according to claim 2, wherein a rate of change from a first insurance premium in a first period to a first insurance premium in a second period is different from a rate of change from a first net premium valuation in the first period to a first net premium valuation in the second period.

6. The communication device according to claim 5, wherein a rate of change from a second insurance premium in the first period to a second insurance premium in the second period is different from a rate of change from a second net premium valuation in the first period to a second net premium valuation in the second period.

7. The communication device according to claim 6, wherein the first insurance is a life insurance and the second insurance is an auto insurance.

8. The communication device according to claim 6, wherein the second insurance premium drops when the first insurance premium drops.

9. A system comprising:
a communication device including a display, the display being capable of showing a first insurance premium of a first insurance and a second insurance premium of a second insurance, and the second insurance premium rises when the first insurance premium rises;
a wearable device including a sensor for collecting a first data, the first data being related to biological information, the wearable device being capable of communicating with the communication device;
a server capable of communicating with the communication device.

10. The system according to claim 9, wherein the display is capable of showing a first net premium valuation of the first insurance and a second net premium valuation of the second insurance, the first net premium valuation being different from the second net premium valuation.

11. The system according to claim 9, wherein the first insurance is a life insurance and the second insurance is an auto insurance.

12. The system according to claim 9, wherein the second insurance premium drops when the first insurance premium drops.

13. The system according to claim 10, wherein a rate of change from a first insurance premium in a first period to a first insurance premium in a second period is different from a rate of change from a first net premium valuation in the first period to a first net premium valuation in the second period.

14. The system according to claim 13, wherein a rate of change from a second insurance premium in the first period to a second insurance premium in the second period is different from a rate of change from a second net premium valuation in the first period to a second net premium valuation in the second period.

15. The system according to claim 14, wherein the first insurance is a life insurance and the second insurance is an auto insurance.

16. The system according to claim 14, wherein the second insurance premium drops when the first insurance premium drops.

17. A device comprising an application, the device being capable of showing a first insurance premium of a first insurance and a second insurance premium of a second insurance to a display by using the application, the first insurance being different from the second insurance, and the second insurance premium rises when the first insurance premium rises.

18. The device according to claim 17, wherein the device is capable of showing a first net premium valuation of the first insurance and a second net premium valuation of the second insurance, the first net premium valuation being different from the second net premium valuation.

19. The device according to claim 17, wherein the first insurance is a life insurance and the second insurance is an auto insurance.

20. The device according to claim 17, wherein the second insurance premium drops when the first insurance premium drops.

21. The device according to claim 18, wherein a rate of change from a first insurance premium in a first period to a first insurance premium in a second period is different from a rate of change from a first net premium valuation in the first period to a first net premium valuation in the second period.

22. The device according to claim 21, wherein a rate of change from a second insurance premium in the first period to a second insurance premium in the second period is different from a rate of change from a second net premium valuation in the first period to a second net premium valuation in the second period.

23. The device according to claim 22, wherein the first insurance is a life insurance and the second insurance is an auto insurance.

24. The device according to claim 22, wherein the second insurance premium drops when the first insurance premium drops.
